(19) United States
(12) Patent Application Publication
(10) Pub. No.: US 2008/0073376 A1
(43) Pub. Date: Mar. 27, 2008

(54) Frozen carbonated modulating dispensing valve and/or flavor injection

(75) Inventors: David B. Gist, Grayslake, IL (US); Kyle B. Elsom, Batavia, IL (US); Peter F. Wolski, Chicago, IL (US); E. Scott Sevcik, Crystal Lake, IL (US); Gregory M. Billman, Hoffman Estates, IL (US); Mark R. Lytell, Glendale Heights, IL (US); Santhosh Kumar, Woodridge, IL (US)

Correspondence Address: PYLE & PIONTEK LLC, 221 N. LASALLE STREET, SUITE 2036, CHICAGO, IL, 60601, US

(73) Assignee: IMI Cornelius Inc.

(21) Appl. No.: 11/786,362

(22) Filed: Apr. 11, 2007

Related U.S. Application Data
(60) Provisional application No. 60/791,488, filed on Apr. 12, 2006.

(51) Int. Cl. B67D 5/60; B67D 3/00; B67D 5/06

(52) U.S. Cl. 222/145.5; 222/504; 222/505

(57) ABSTRACT

This invention relates to a dispenser, for preferably Frozen Carbonate Beverage (FCB) product, having valves that can be manually or electrically operated in response to electronic controls. The valve has a jam dispensing position, and can be used with an additive, such as flavors, injector. A power failure back up is provided to close the valve, along with sanitation and optional purging cycles. Product dispense is provided only when sensed to have a desired consistency and/or in a condition to prevent splashing. Additive dispense is provided only when product is present. The dispenser can have a monitor and suitable controller to dispense strips or layers of different additives or flavors into the product.

This application is a United States Non-Provisional patent application based upon and claiming the priority and filing date of U.S. Provisional patent application Ser. No. 60/791,488, filed Apr. 12, 2006.

The invention herein relates to a beverage dispenser, for example, see co-pending U.S. provisional application Ser. No. 60/601,738, filed Aug. 13, 2004 now application Ser. No. 11/202,609, filed Aug. 12, 2005 which is herein fully incorporated by reference, and owned by the same assignee of the present application, and more particularity to a frozen (actually semi-frozen) carbonated beverage (FCB) dispenser having an electronically controlled dispensing valve for controlling the functions of the beverage dispenser, such as, but not limited to, dispensing semi-frozen products, and/or being capable of additional flavor or other additives injection into the dispensed semi-frozen product.

### BACKGROUND OF THE INVENTION

Heretofore, it has been known to provide a beverage dispenser, including remote towers, for various beverages such as, for example, frozen carbonated beverage or other “slushy” type products, with functional controls which are operated by, for example, pressing a cup against a lever associated with the dispensing nozzle or pushing a button on the dispenser to select a product. Buttons are also used for other functions. See U.S. Pat. Nos. 4,890,774 and 5,129,548, which show buttons on a dispenser to control the size of the liquid drink, as contrasted to a semi-frozen product, dispensed. It is also known to use electronically controlled valves with solenoid or stepper motor actuators for dispensing liquid drinks, such as soda or juice (an example is a Cornelius Base Dispense Valve 620607718), as contrasted to “slushy” or semi-frozen products, for example, frozen carbonated beverage. Prior to the present invention, electronic controlled valves were not used to dispense such slushy or semi-frozen products.

As to such frozen type products, it is known to add flavors by blenders or the like to the same. For example, U.S. Patent Publication 2002/0189460 A1 discloses an automatic flavor injected blending apparatus which can blend into a milkshake like product a flavor additive with blades of a blender. It is believed that the device shown therein is not consumer operated, but instead is operated by a trained employee/owner of the facility in which the device is located.

U.S. Pat. No. 6,689,410 discloses another device for providing a trained operator dispensed milkshake type product, including probably an employee dispensing and blending therein of a customer desired flavor utilizing an auger with backflow induced blending.

U.S. Pat. No. 6,223,948 shows beverage dispensing of a liquid beverage, say a syrup and diluent, such as water, mixture, with a dispensing valve having a separate flavor additive injector. The flavor additive injector is connected to the beverage dispenser valve and has a bypass linker.

U.S. Pat. No. 4,580,905 discloses a flavor mixing and dispensing device for a frozen confection machine with a rotary mixer therein that purports to discharge substantially all of the previously mixed product to minimize flavor carry over to a sequentially different flavored product. The device is stated to be controlled so that the piston-mixer thereof in its lowermost position displaces substantially all of the mixture from its mixing chamber.

It is known to use electronically controlled liquid beverage dispensing valves. For example, see U.S. Pat. No. 5,156,301 (Re. 35,780).

### BRIEF SUMMARY OF THE PRESENT INVENTION

The present invention provides a dispenser that features an electrically operated frozen carbonated beverage valve that can be electronically controlled. While the invention may be mainly used with carbonated product, certain aspects thereof could be used with noncarbonated products, such as juice in a semi-frozen state. In such instances, the product may have to be pumped rather than “pushed” by the CO₂ gas. The valve is also capable of being built either as an electrically or electronically operated or manually operated valve. Preferably, the dispenser method and apparatus of the present invention can be consumer operated, as contrasted to a trained employee operated. The valve also features a jammed product dispense position, wherein the valve discharge nozzle can be opened beyond the normal open dispensing position to dispense any hard or frozen product therein. Further, the valve can be fitted with additional additive or multiple flavor dispensing method and apparatus to dispense further additives or additional flavors into the frozen carbonated beverage in various manners under electric or electronic control, such as in layers, simultaneously, stripes or in combination, either automatically (programmed) or in a manner otherwise selected by the user or consumer.

The additives or flavors may be injected directly into the frozen carbonated beverage with or without the use of a mixing chamber formed as a part of the dispenser nozzle and/or flavor additive structure and/or downstream of the frozen carbonated product dispensing valve. It should also be understood that in addition to flavors and/or flavor concentrates other additives such as alcohols, no-low or full caloric additives, colors, gases (CO₂ or others), essences, chocolates, dairy and/or soy products, and nutraceuticals and/or vitamins could be injected. Usually these injected materials should be in fluid, gas or liquid form. For a shortened presentation the term “flavor” or “flavor injection” is used, but it should be understood that, unless otherwise limited, this term could include any of these other additives.

To prevent contamination of one flavor to the next, the dispenser and its flavor additive structure can optionally be fitted with means for purging the flavor additive system, say with a purge fluid or gas, such as the carbon dioxide used to form a frozen carbonated beverage. Such operation can be programmed to be carried out automatically with a flavor change or in a periodic manner.

Further, the present invention includes a method and apparatus for sanitizing the flavor or additive structure, either in a selected, or periodic or programmed manner.

The present invention includes means for closing the FCB dispensing valve should there be a power outage, disrupting the normal closing and opening operation of this valve. The invention includes the sensing of a power outage and initiating an electric signal to move the valve to its closed position powered, say by a battery or a charged capacitor back up.

Additionally the method and apparatus of the present invention can detect the state of the slushy product by sensing the torque or amperage of the motor used to blend the product. As is conventional, response thereto the amount or degree of refrigeration supplied the dispenser can be controlled, increasing refrigeration if the torque or amperage sensed is low to additionally freeze the product, and decreasing the refrigeration if the torque or amperage sensed is high to less freeze the product and prevent freeze ups. Further and as part of this invention, a signal proportional to the sensed torque or current can be used to control whether any product is to be dispensed and set or configured so as to only dispense product when it is in a desired state, i.e. not too soft or not too hard.

While described in the context of a frozen carbonated beverage dispenser, one or more of these features and/or invention can be adapted to other type beverage dispensers such as for drinks, soda, juice, beer or any other type beverage or drinks.

### OBJECTS Of The Present Invention

It is an object of the apparatus and method of the present invention to provide electrically operated dispensing valve for and electric or electronic dispensing of frozen carbonated beverage.

Another object of the apparatus and method of the present invention is to provide a dispensing valve for dispensing of jammed or hard frozen beverage therein.

Still another object of the apparatus and method of the present invention is to provide selected additions, such as flavors, to the frozen carbonated beverage.

Yet another object of the apparatus and method of the present invention is to prevent carryover and/or provide purging of the previous additional additive or flavor, if different from the next to be injected.

Another object of the apparatus and method of the present invention is to, if desired, use gas or CO₂ which is also used for carbonation, to purge the previous additive or flavor.

Still another object of the apparatus and method of the present invention is to provide for electronic control of the frozen carbonated beverage dispenser.

A further object of the apparatus and method of the present invention is to provide for a frozen carbonated beverage dispensing valve that can be constructed to be either manually or electrically operated.

Still another object of the apparatus and method of the present invention is to sense the condition of the frozen product and/or the torque or amperage on the motor used to blend the product and to control the dispense of the product so that product is dispensed only when in a desired state and not dispensed when not in the desired state.

The foregoing and other objects of the apparatus and method of the present invention will be apparent from the following written description and claims and the accompanying drawings.

### BRIEF DESCRIPTION OF THE DRAWINGS

FIG. 1 is a perspective view of a frozen carbonated beverage dispenser embodying the present invention, showing a valve on the dispenser coverable by a consumer operated interface.

FIG. 1A shows an alternative consumer operated interface, similar to that disclosed in the earlier filed provisional application Ser. No. 60/601,738, now Ser. No. 11/202,609.

FIG. 1B shows yet another alternative interface and how it and its associated valve may be mounted on the dispenser;

FIG. 2 is a schematic of the dispenser shown in FIG. 1 which includes a sanitation mode and a CO₂ purge mode;

FIG. 2A is a schematic similar to FIG. 2, but is without the CO₂ purge shown in FIG. 2;

FIG. 3 is a schematic of the flavor or additive system regulator manifold for the dispenser shown in FIGS. 1, 2 and 2A;

FIG. 4 is a schematic of the sanitation/purge manifold system for the flavor or other additive system shown in FIGS. 1 and 2;

FIG. 5 is an exploded, side elevational view of one of the frozen carbonated beverage valve shown in FIGS. 1 and 2;

FIG. 6 is an enlarged, exploded, perspective of the valve shown in FIG. 5;

FIG. 7 is a further enlarged, cross-sectional view of the valve shown in FIGS. 5 and 6 with electrical operation;

FIG. 7A shows an alternative connecting nipple 115 on the valve having a key which cooperates with a keyway to prevent rotation.

FIG. 8 is a side elevational, exploded view similar to FIG. 5, but showing the valve of FIG. 5 built for manual operation;

FIG. 9 is an enlarged perspective, exploded view similar to FIG. 6, but showing the manually operable valve of FIG. 8;

FIG. 10 is an enlarged cross-sectional view similar to FIG. 7, but showing the manually operable valve of FIGS. 8 and 9;

FIG. 11 is a schematic view of the valve of FIGS. 5-7 showing its partial integration into the dispenser and the flavor injector;

FIG. 12 is a schematic view of the valve of FIG. 11 shown in a “closed” position;

FIG. 13 is a schematic view of the valve of FIG. 11 shown in an “open,” normal product dispensing position;

FIG. 14 is a schematic view of the valve of FIG. 12 shown in a further opened “jammed” or frozen product purge position;

FIG. 15 is an exploded view of the regulator manifold shown in FIG. 3;

FIG. 16 is an exploded view of the sanitation or purge manifold shown in FIG. 4;

FIGS. 17A and 17B are cross-sectional views of the additive, flavor or fluid injection manifolds without (FIG. 17A), and with (FIG. 17B) a mixing chamber;

FIGS. 18A, B, C and D are further perspective, top, front, and side views, respectively, of the additive or injection manifold of FIG. 17A;

FIGS. 19A to 19E are back and front perspective views, front elevation, top and back elevation views, respectively, of the freeze barrel face plate attached onto the dispenser and onto which the valve of FIGS. 5-7 or FIGS. 8-10 attaches;

FIG. 20 is a schematic flow chart showing the overall operation and refers to the flow charts 2B, 3C and 4D disclosed in FIGS. 21, 22, 22A, and 23, respectively;

FIG. 21 is an expanded schematic for portion 2B of FIG. 20;

FIG. 22 is an expanded schematic for portion 3C of FIG. 20;

FIG. 22A is an expanded schematic for portion 5E of FIG. 22;

FIG. 23 is an expanded schematic for portion 4D of FIG. 20; and

FIG. 24 is a cross-sectional view showing how the dispenser, its freeze barrel face plate, dispensing valve and flavor injector manifold are assembled.

FIG. 25 is an enlargement of a portion of FIG. 24, showing how the plunger engages the stop seat so as not to crush the quad-ring seal and the diffuser construction.

### DESCRIPTION OF THE PREFERRED EMBODIMENTS

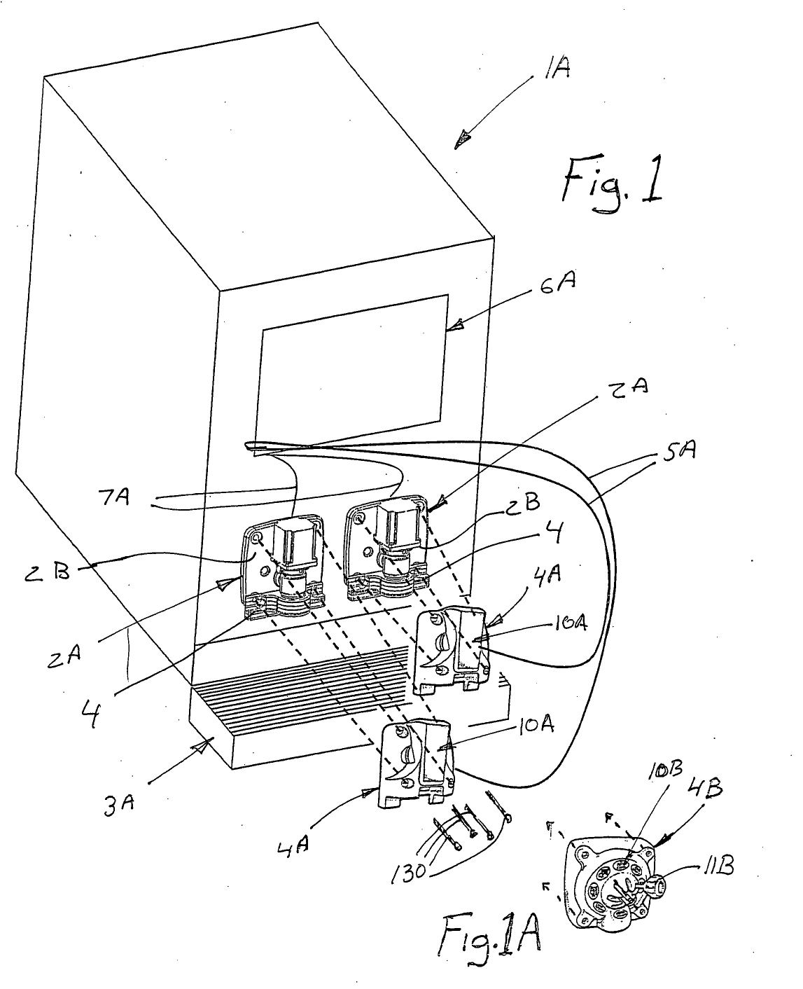

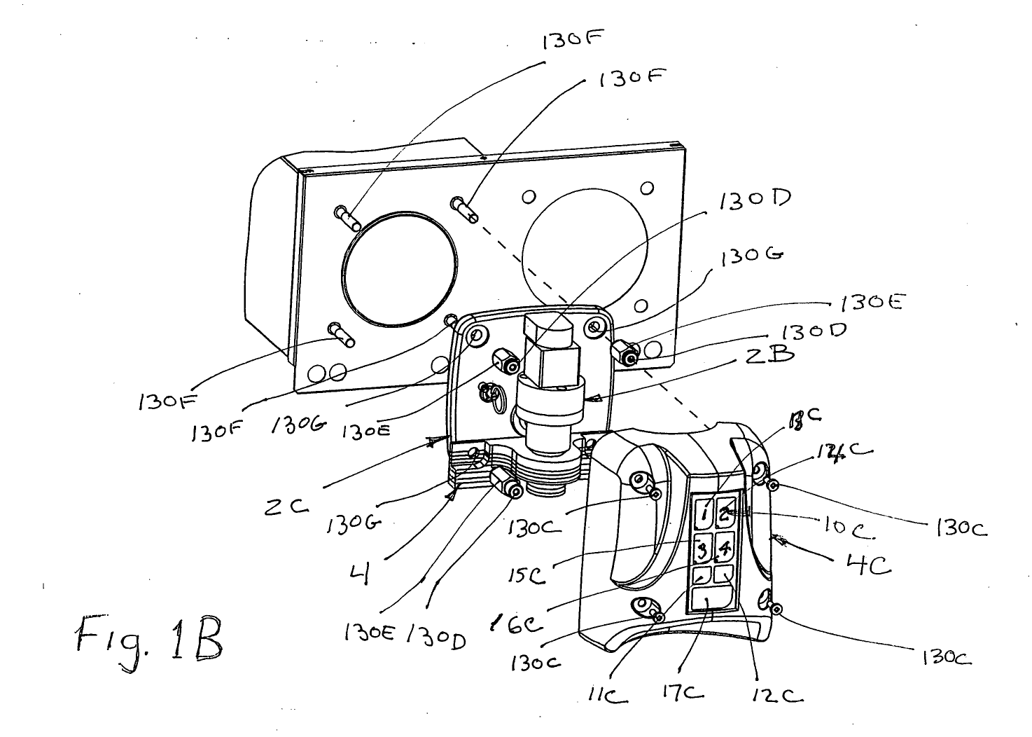

Referring to FIG. 1, the dispenser 1A of the present invention is for dispensing, in this instance, frozen carbonated beverage (FCB). The invention disclosed herein, or at least aspects thereof, could be used to dispense fluids or other type products, such as drinks, juices, sodas, beer, etc., and even gases, such as for example CO₂. As shown the dispenser 1A has product dispensing valves 2A mounted on the front of a face plate 2B and above a drip tray 3A. Over the valves 2A are fitted customer interface units or controls 4A which can control the operation of the first and second dispensing valves 2A therebeneath, via a first and second set of cables 5A, connecting interfaces 4A to an internal electronic control means 6A, and connecting cables 7A from the electronic means 6A to the first and second dispensing valves 2A. The electronic control means 6A of FIG. 1 can include the various electronic components shown in FIG. 2 or 2A, such as the controller 2, controller 6, inverter board 37, etc.

As shown in FIG. 1 and indicated by the dotted lines, the interfaces 4A can slip over and be fitted and held onto the valves 2A by bolts 130 (shown in FIG. 1), studs, screws or clips or other fastening means.

Referring to 1A, an alternative form of control or, interface 4B, a game controller, like one of those shown in the co-pending provisional application No. 60/601,738, now nonprovisional application Ser. No. 11/202,609, is shown. It should be understood that any of the interfaces or controllers disclosed in that application could also be used with the dispenser 1A and valve(s) 2A of the present invention. It should be further noted that these interfaces are designed for and are to be operated by the customer or consumer, and need not be operated or used solely by a trained employee or operator. Of course, the latter type person could operate these interfaces, and hence the dispenser and its valves.

As shown in FIGS. 1A and 2B, the controller or interface 4A, 4B and/or 4C (FIG. 1B) can have a keypad 10A (FIG. 1), 10B (FIG. 1A) including a joy stick 11B, or 10C (FIG. 1B) with various functions. For example, as shown in FIG. 1B, the keypad can have, “layer” 11C “stripe” 12C, “flavor 1” 13C, “flavor 2” 14C, “flavor 3” 15C, “flavor 4” 16C, and “dispense” 17C. The dispenser is set up so that if a customer changes his/her mind before hitting dispense 17C, and he/she can wait a shorter period of time (about 4 seconds), then the prior selection is cancelled, and the customer may then reselect.

As noted in FIG. 1B, the interface 4C is held to or over the body of valve 2B, in this instance by a fastening means 130C which cooperates with small thread openings 130D in the nuts 130E. The nuts 130E in turn, fit on studs 130F which fit into openings 130G in the face plate 2C.

Referring to FIG. 2, a general schematic illustrating the apparatus and method of the dispenser 1A of the present invention is shown. As shown therein, the solid arrows generally indicate flow passages and conduits with flows in the direction of the arrows. The dashed lines generally indicate electrical control or supply lines. As is shown there, the user control interface 1 (like 4A) is used to control the operation of a valve controller 2, somewhat similar to a Cobra valve controller made by IMI Cornelius, Inc., the assignee of the present invention.

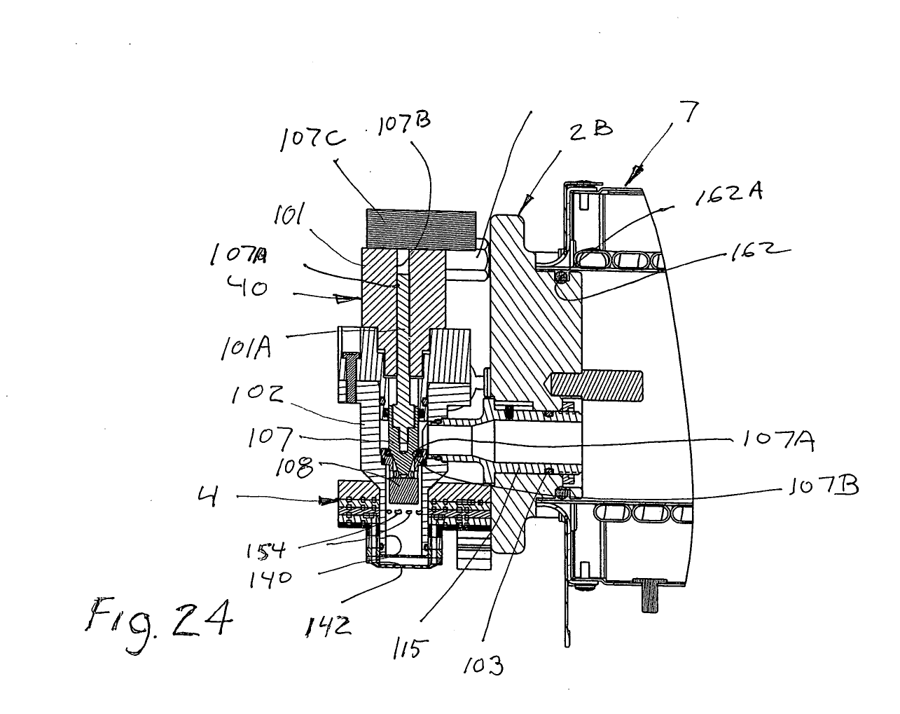

The product, in this instance FCB, is dispensed by a valve 40 which is operated by its associated electrical actuator 3 which is in turn activated by its controller 2, via control line 2/3. The actuator may be a solenoid, or preferably, a stepper motor made by Haydon Switch and Instrument, Inc., as model 35H4J-2.33-905 incorporating position feedback with encoder by US Digital as model E5S 400. (See FIG. 24 at 107C). Each valve 40 may be fitted at its bottom or discharge end with its own additive or flavor injector module 4. With operation of the valve 40 and optional operation of the associated flavor or additive module 4, in this instance, frozen carbonated beverage with or without additional additives (flavors or fluid) can be dispensed into a cup 5 from the FCB dispenser's product barrel 7. The valve 40, of course, would be “plugged” into the end of the barrel 7 (see FIG. 24), as indicated by the arrow 40/7, and as will be more fully disclosed below. The operation of the dispenser can be via the conventional controller 6, made by the assignee of the present invention. As is conventional, the dispenser barrel 7 can be fitted with a beater (not shown) in the barrel, powered by a motor 8 located at the back of the barrel for scraping the frozen product off the interior barrel walls prior to and during the dispense.

Now as part of the present invention, a flow sensor 9 is fitted to determine the readiness to dispense by sensing the flow ability of the product. As is conventional in a FCB dispenser in which the present invention can be incorporated or provided, there is a blendonator 10 (a carbonator would be used in a carbonated drink dispenser), a product pump 11, a C0₂ regulator 12, a syrup flow valve 13, a diluent or water flow valve 14, a C0₂ pressure switch 15, a syrup pressure switch 16 and a water pressure switch 17. The above devices control and regulate the dispense of C0₂ for carbonation from a C0₂ source (arrow 18), such as a pressurized tank, the dispense of syrup for principally mixing with the frozen product from a syrup source (arrow 19), and water from a source (arrow 20) such as a city supply or from a treated supply. The water, syrup and CO₂ are mixed in a desired ratio and semi-frozen by refrigerant (arrow 87), supplied to the barrel 7, to form the semi-frozen FCB mixture of water, syrup and C0₂.

As is conventional, water from the source 20, syrup from the source 19 and CO₂ from the source 18 flows past their respective pressure switches 17, 16 and 15, through the water flow valve 14, syrup flow valve 13 and CO₂ regulator 12, into the blendonator 10. As is shown by the flow lines, the water and syrup are first mixed together and then that mixture and the CO₂ is sent to the blendonator. From the blendonator 10, upon demand and under control, as will be explained later, these constituents are in desired ratios (such as 3 to 11 parts water, to 1 part syrup, and 0 to 5 volumes of CO₂) combined to form the desired FCB mixture. “Volume of CO₂” is a term known to persons skilled in the art of carbonated beverages. For further information on this point see the paragraphs at the end of this application.

That mixture is then sent through a mixture flow sensor 9, to the FCB product barrel 7 wherein it is at least semi frozen, by a conventional refrigeration system, the refrigerant flow being indicated by the arrow 87, but not fully shown. The freeze barrel 7 has conventional beater means (not shown) therein which is powered by the beater motor 8. As noted above the torque of the beater motor 8 or its current or amperage, which is proportional to the motor torque, can be used to sense the state of the product in the freeze barrel 7, that is, indicate whether it is within the desired range, or too frozen or in a “defrost” state. This signal, indicative of torque or amperage, can be sensed by the inverter board 37 and from there sent to the controller 6. If the torque or current sensed is within acceptable limits, the refrigeration supplied can be normal. If the torque or current sensed is low, the product needs to be further frozen and additional refrigeration can be supplied. If the torque or current sensed is high, the product is at risk of freezing to “hard” and the amount of refrigeration can be reduced. Additionally as part of the disclosed invention herein, these same sensed signals can be used to determine whether or not a product dispense should occur. That is if the product is too frozen or insufficiently frozen, the controller in response to these sensed parameters can prohibit the dispense valve 40 from opening. Thus, product is dispensed only when it has a desired consistency. While the “trigger points” for a dispense could be different from those used to control the refrigeration, it has been found to use the same points as or refrigeration control has produced a satisfactory product for the consumer.

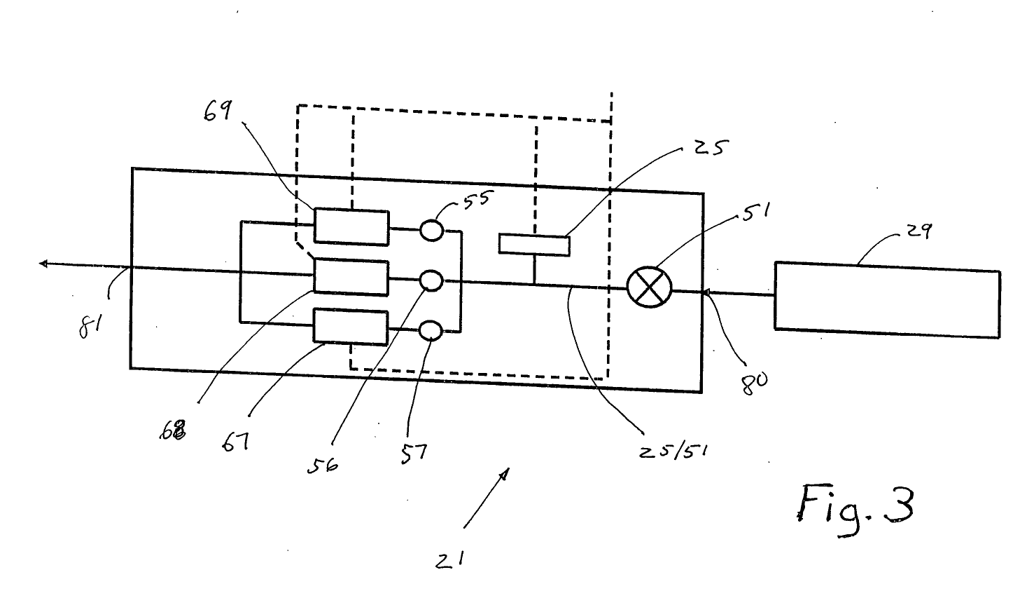

From the barrel 7, the semi-frozen carbonated product is sent, when the valve 40 is opened, through the dispensing valve 40 by new product being forced into the barrel under pressure. This valve 40 has a lower body 39 thereon, and an actuator 3 and will be more fully described in connection with FIGS. 5 to 8 below. As shown, the actuator 3 is connected via control line 2/3 to the controller 2. The controller 2 is a prototype made by IMI Cornelius. The controller 2, is connected to the user interface 1 (in FIG. 2) by a control line 1/2.

Additionally, the controller 2 may also operate a customer display 38. The display could be a conventional sign and/or an electronic monitor, and the latter could display: commercials and advertising, pictures of beverage (FCB or drink), customer promotions, operator instructions, ingredient information, beverage color options, pouring instructions, beverage additive options, beverage additive selection instructions, recipes for novel drinks, video or other games. The foregoing could occur in various orders and combinations as desired or required. The display could be built into the dispenser 1A.

Now as part of the invention, the operability of the dispenser is checked, as noted above, by sensing the current to the beater motor 8. If the current is too high, then the product is freezing too much and refrigeration is reduced by the controller 2 which also controls the dispenser's refrigeration system (not shown) and its compressor's (not shown) operation. If the current sensed in the beater motor 8 is too low, then the product is defrosting, or in a “defrost” state as known in the art, and is in need of additional refrigeration and that is then also supplied by the refrigeration system and compressor, via controller 2. As noted in the present invention, this signal can also be used to control the dispense so that only the desired high quality product is dispensed, and where there is no dispense when below the desired quality. Additionally for service, maintenance and set up, the controller 2 has a communications port 43 to which appropriate test or service devices can be connected.

As noted earlier, the control system also includes the controller 6 and the inverter board 37 which provides, in this instance pulse D.C. power to operate the beater motor 8 at the desired speed under control of the controller 6.

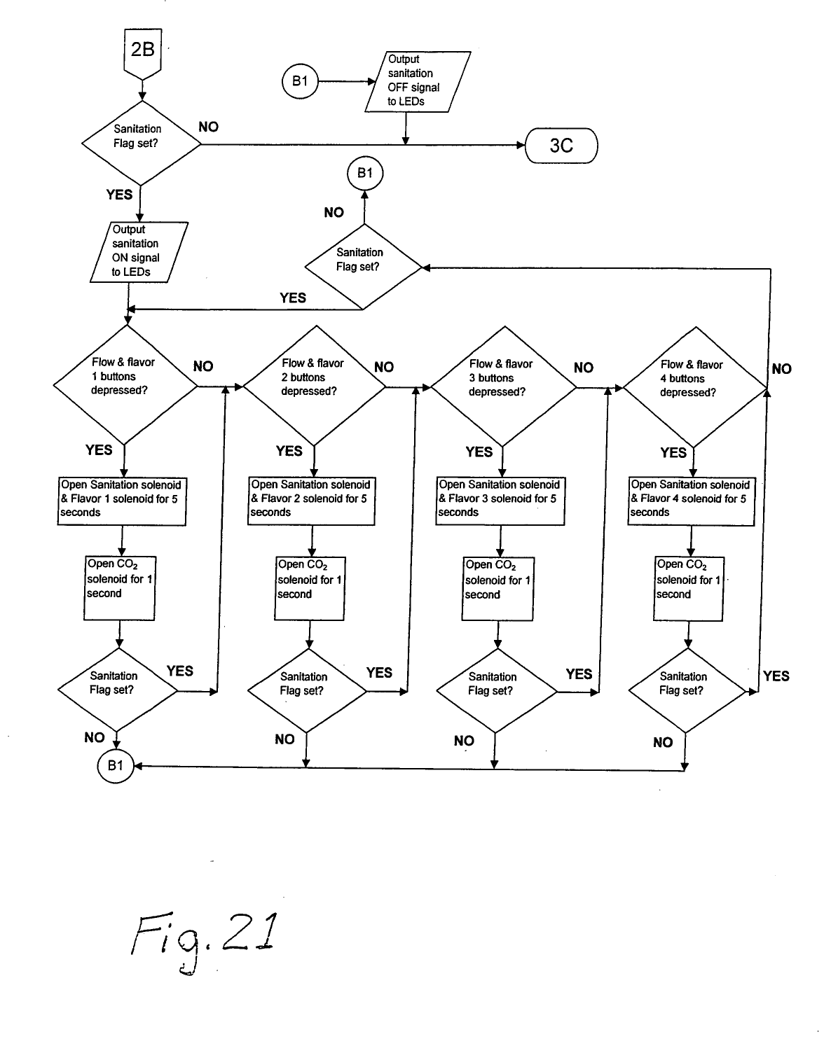

For power emergencies, a power loss detection means and an auxiliary power source 41 can be provided. This could be a battery or capacitive system and supplies sufficient power to shut down the dispenser and particularly close the FCB dispensing valves in case of a power failure. This is accomplished when the control board's internal power system detects that incoming line voltage has dropped below a fixed value for a fixed amount of time. The control switches to auxiliary power and executes the shutdown process. See FIG. 20. This shut down process would include driving the stepped control valve closed a fixed number of steps to guarantee that valve does not leak (in case someone was in the middle of pouring from the valve, such as 40, at the instant of power interruption).

As is shown, the additives or flavors or fluids injection module 4 is mounted below the valve 40 and operates on and with the semi-frozen product discharged from the valve 40. The module 4 receives each of the additives, flavors, or fluid from, in this instance, four different additive, flavor or fluid sources 33, 34, 35 and 36. By way of example and not limitation the additives could be such as cherry, lemon, strawberry, and rum (with alcohol) flavors or fluids. Of course, different additives, flavors or number of flavors could be provided. The additives or flavors are drawn from the sources by, in this instance, flavor or fluid injector pumps, one for each flavor or fluid, and in this instance from pumps 29, 30, 31 and 32. Each of the pumps 29, 30, 31 and 32 discharges to its own regulator manifold 21, 22, 23 and 24, respectively, as each flavor could have its own flow characteristics that need to be taken into account.

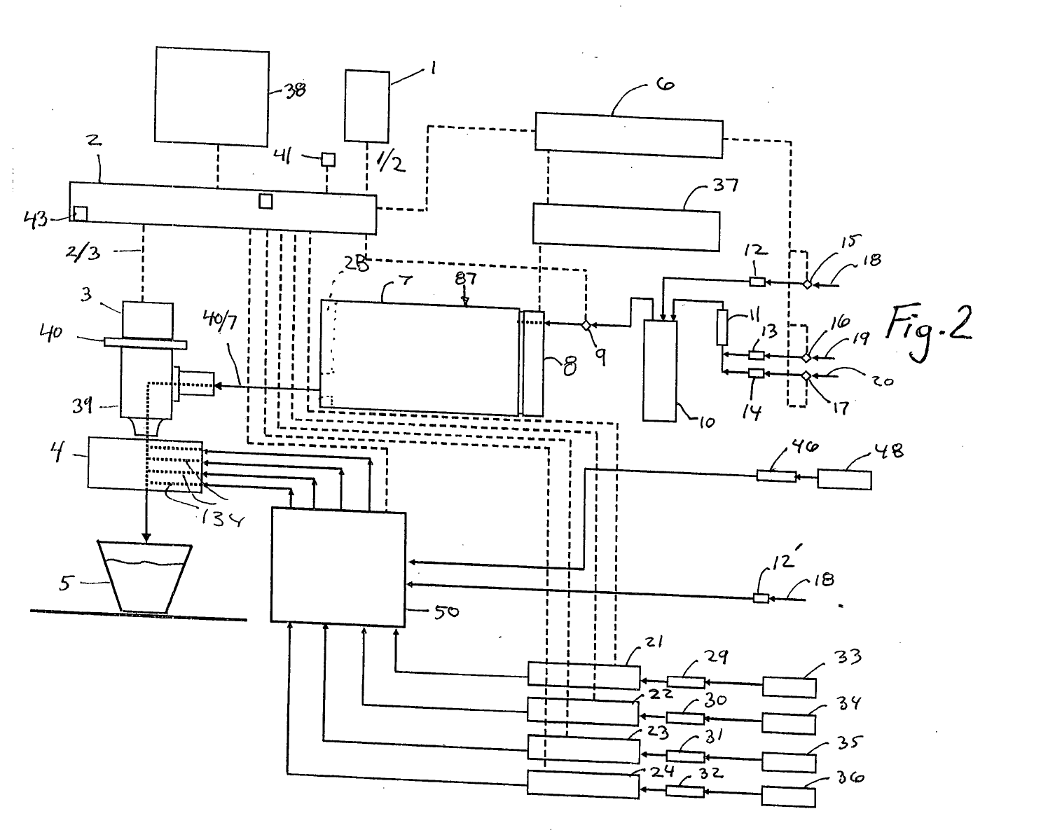

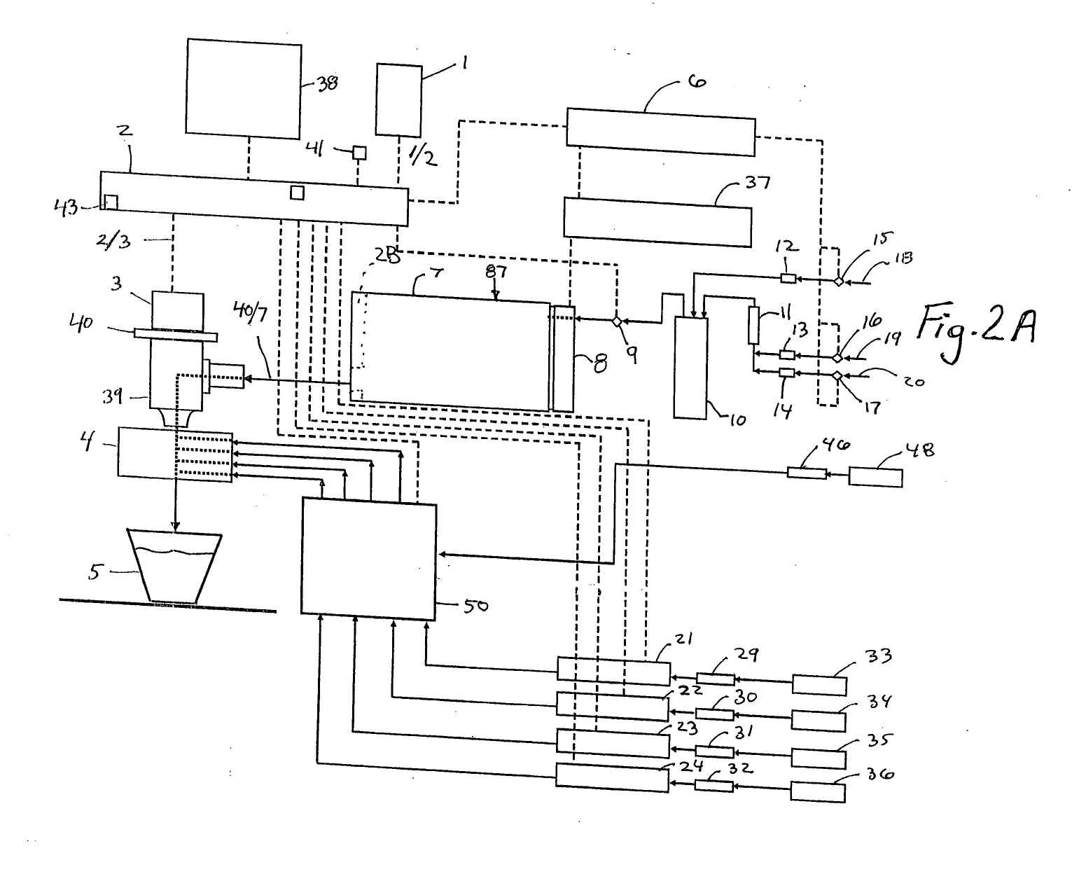

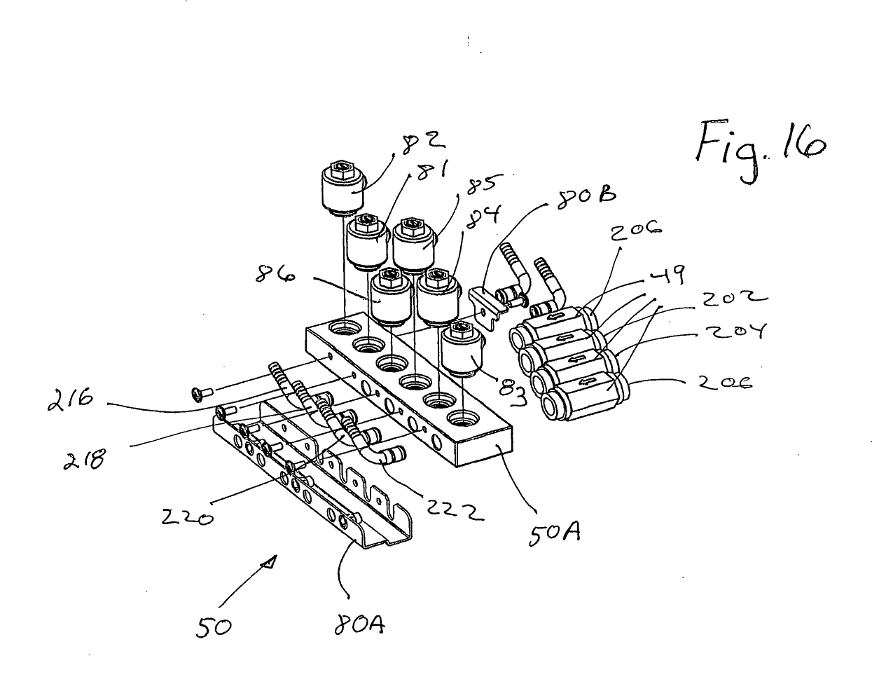

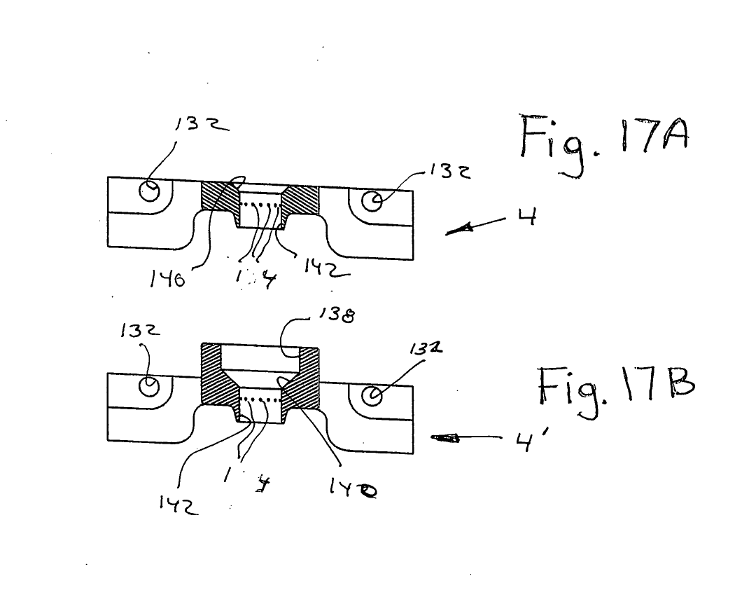

These regulator manifolds, 21 to 24 will be described in more detail below in connection with FIGS. 3 and 15. The various regulated additives, flavor or fluid flows then discharges to a single sanitation/purge manifold 50 (the purge operation may be omitted, if desired, in other embodiments, such as shown in FIG. 2A.). In that FIG. 2A embodiment, the sanitation manifold 50 is still used but no purge operation is carried out. In this version the manifold would simply be a “sanitation manifold 50,” as no purge, and just additive delivery occurs. These operations will again be described in more detail below in connection with FIGS. 4 and 16.

When purged the manifold 50, as shown, could be supplied with C0₂ for purging purposes from the same C0₂ source 18 or from a different source (not shown). For example, a flow divider such as a “tee” (not shown) could be used to permit C0₂ flow to both the blendonator 10 and manifold 50, when desired. Preferably, the flow of C0₂ to the manifold is controlled by a second C0₂ regulator 12′. The manifold 50 can also be provided at the desired time with a sanitizing solution from a container 48 thereof, through and by a pump 46.

The manifold 50 can either supply one or more of the additives, flavors or fluid, in this instance 33-36, or optionally purging fluid or gas 18, in this instance C0₂, or the sanitizing solution 48 in addition to the additive, flavor or fluid to module 4 for purposes of adding additives, flavor(s) or fluids to the FCB, purging the last additive, flavor or fluid before the next is supplied, and/or selectively or periodically sanitizing the module, respectively.

Now that the general operation has been described, the construction will be described in more detail in the following order, product valve 40, regulator manifolds 21 to 24, additional sanitation/purge manifold 50, and additive or flavor injection 4.

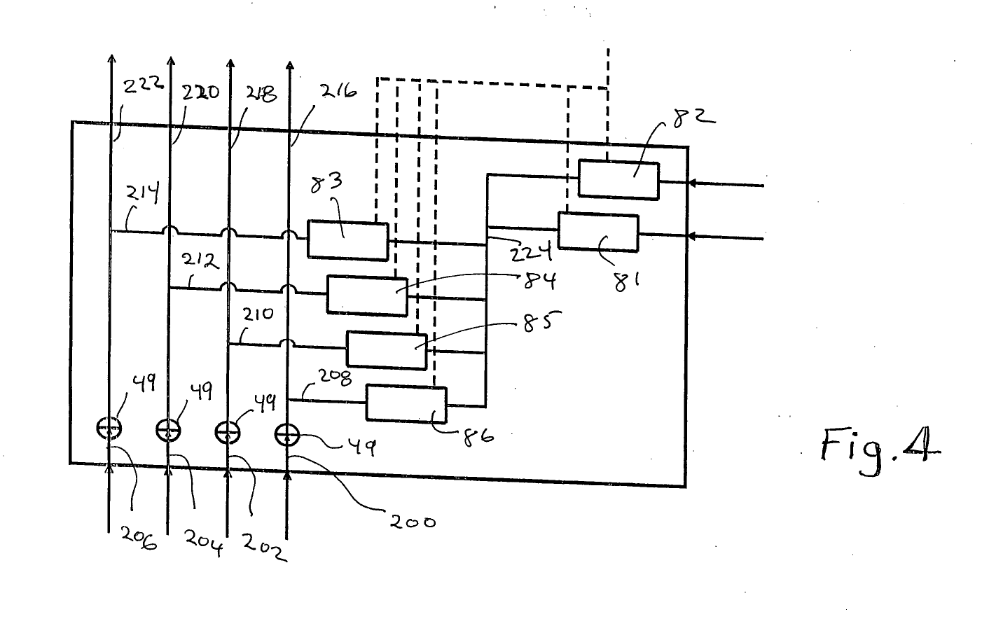

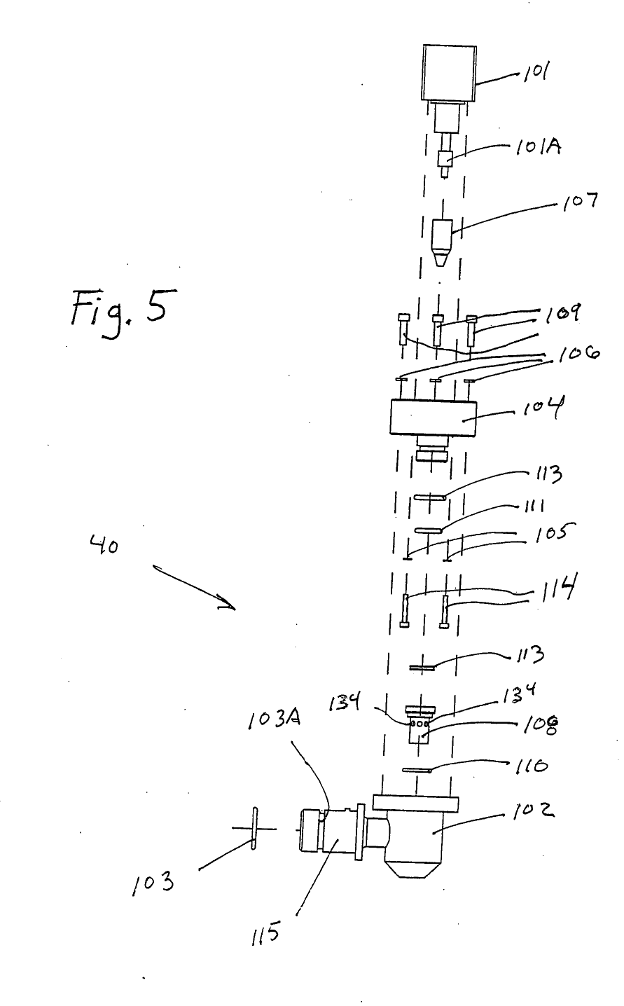

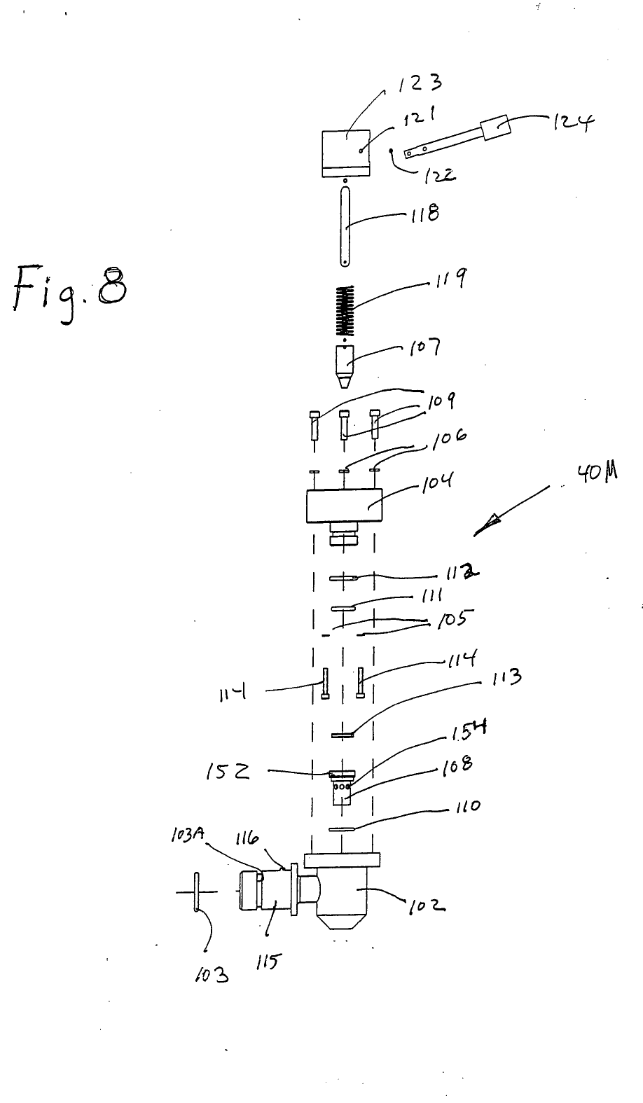

Referring to FIGS. 5 to 7 the product dispensing valve 40 is shown and in detail comprises a lower valve body 102 which is connected to the flow path from the dispenser by a nipple or tubular portion 115 [and sealed by O-ring 117 FIG. 10]. That tubular portion 115 is sealed to the dispenser by an O-ring 103 that fits on an outer groove 103A on the tubular portion 115. The lower portion 102 receivers an upper or top housing portion 104. The portions 102 and 104 can be secured together by various means, and in this instance, by fasteners, in this instance screws 109 with lock washers 106, which pass through opening 109A (FIG. 6) in the portion 104 to engage in threaded openings 109B (FIG. 6) in the lower portion 102. A cavity 109C is formed between and within the top portion 104 and bottom portion 102. Within the cavity 109C is located a diffuser 108 (FIG. 6), which is sealed to the lower step 110A (FIG. 7) in the cavity 109 and lower portion 102 with an O-ring 110. An additional O-ring 111 is provided for forming a seal with movable valve piston or plunger 107.

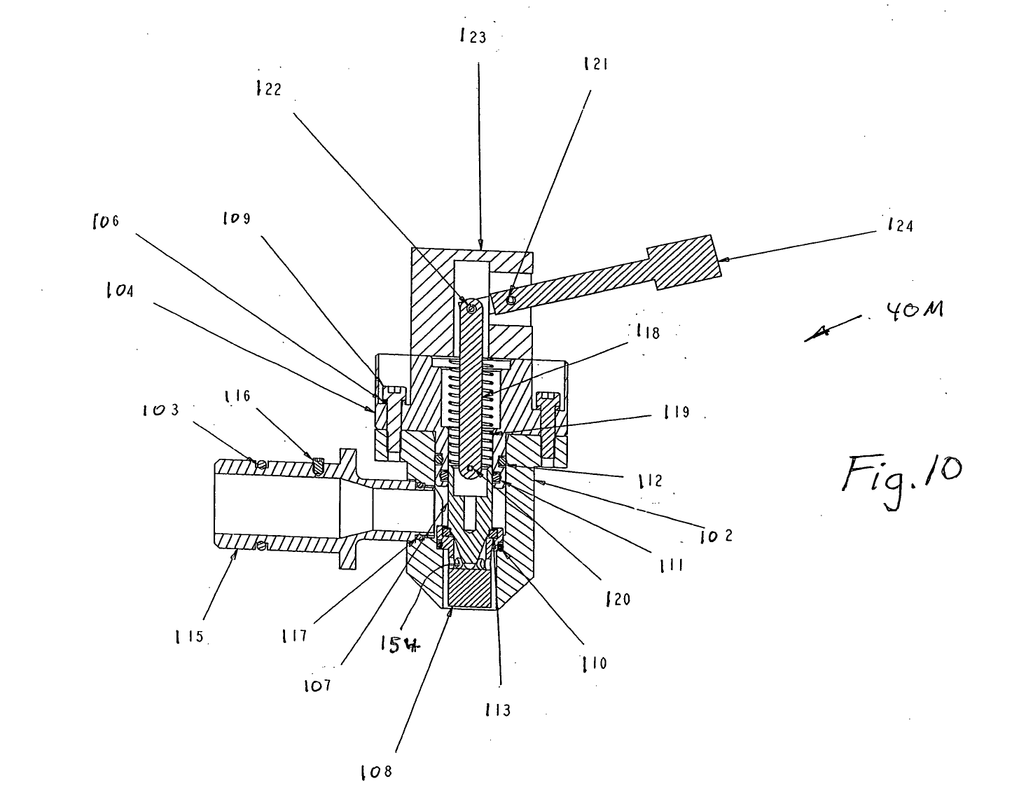

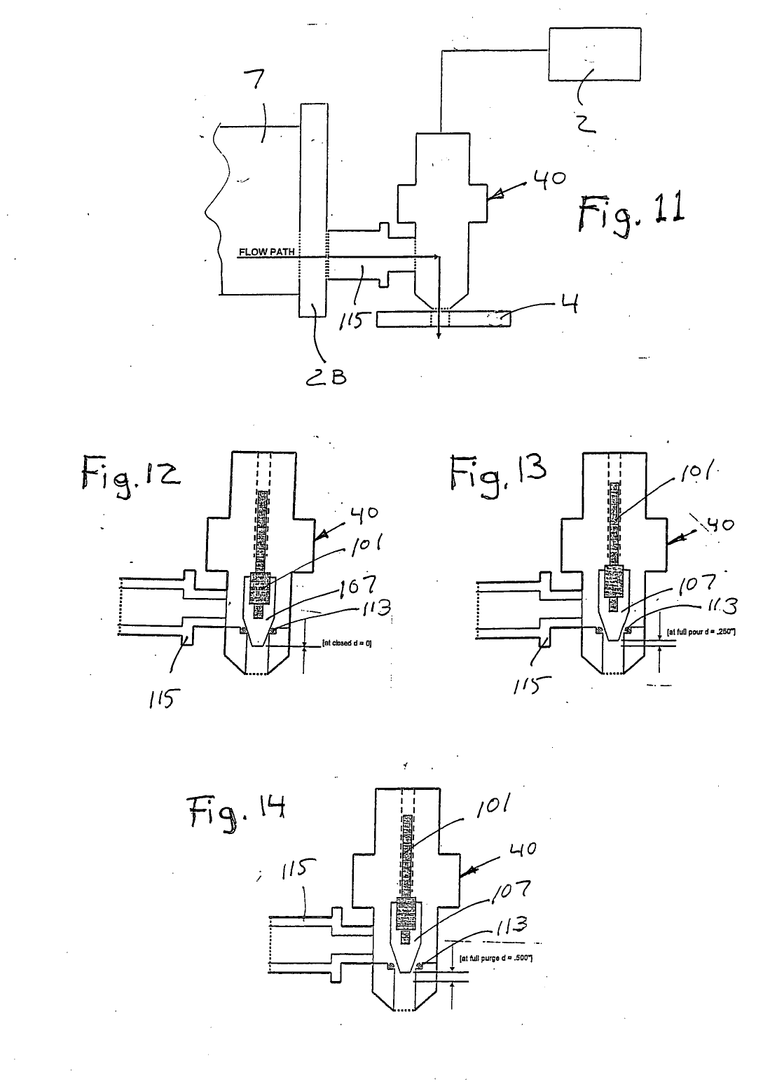

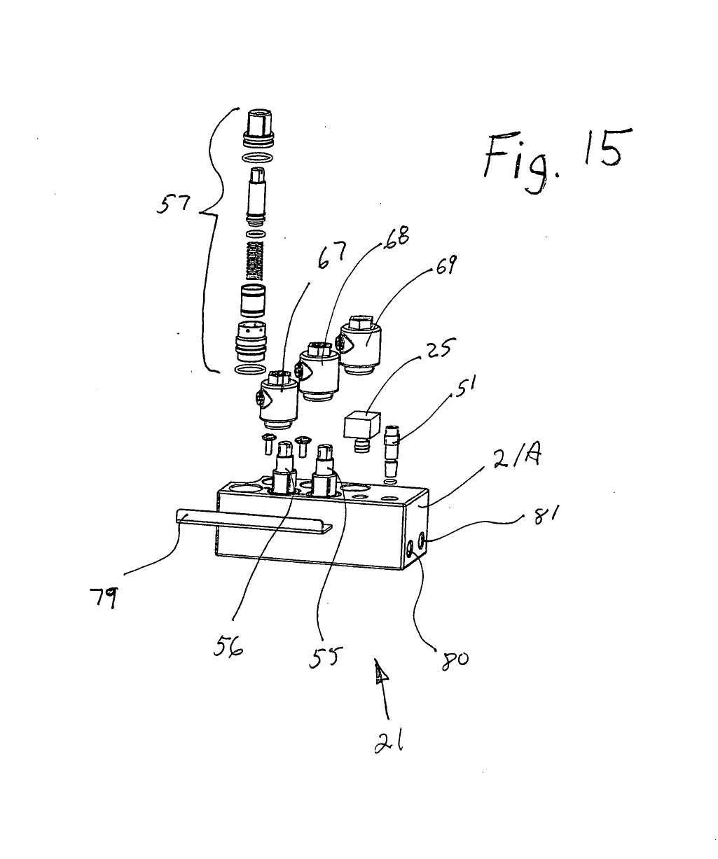

A further O-ring 112 is provided to seal between the portions 102 and 104. A quad-ring 113 is provided in a recess 113A to function as a valve seat for the tip of the plunger 107. The rings 111 and 112 and quad-ring 113, for service reasons are replaceable. The seal or quad-ring could be made of BUNA-N or EPDM. The valve plunger 107 is slidable in the valve 40 between (1) closed (FIG. 12), (2) normal open (FIG. 13) and (3) fully open or purge (FIG. 14) positions, which will be described later. The valve plunger 107 is opened by the electrical actuator 3 in FIGS. 2 and 101 (FIGS. 5-7). The actuator may be as solenoid, or preferably a stepper motor, such as made by Haydon Switch and Instrument, Inc, as model 35H4J-2.33-905 incorporating position feedback with encoder by US Digital as model E5S 400. The actuator is held to the valve 40, and more particularly to the top portion 104, by a plurality of fasteners, namely smaller screws 114 with cooperating lock washers 105. The armature itself is rotary operated being an Acme screw with a moving thread in stator. The actuator has an electric coil not shown and a stator and movable armature 107A onto which the piston or plunger 107 is mounted, as shown in FIGS. 5 to 7. The fasteners pass through openings 114A in the upper portion 104 and fit into threaded openings (not shown) in the actuator body 101.

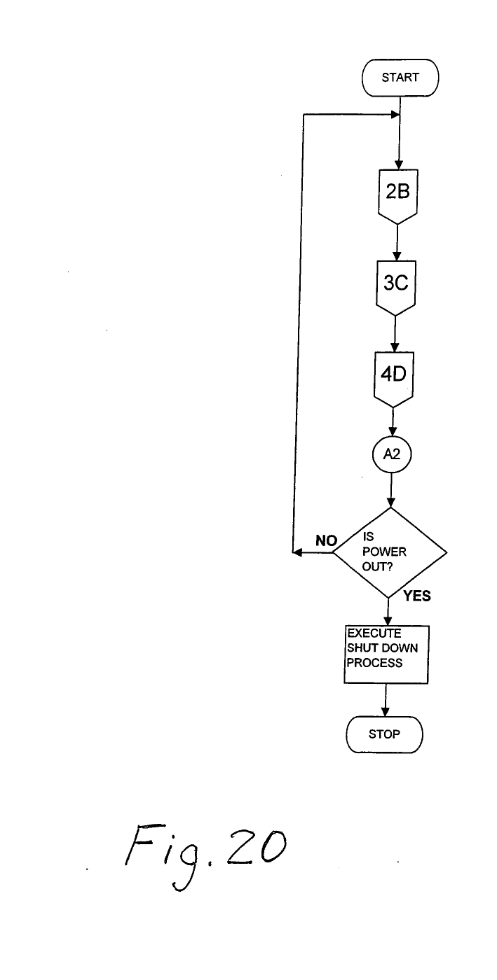

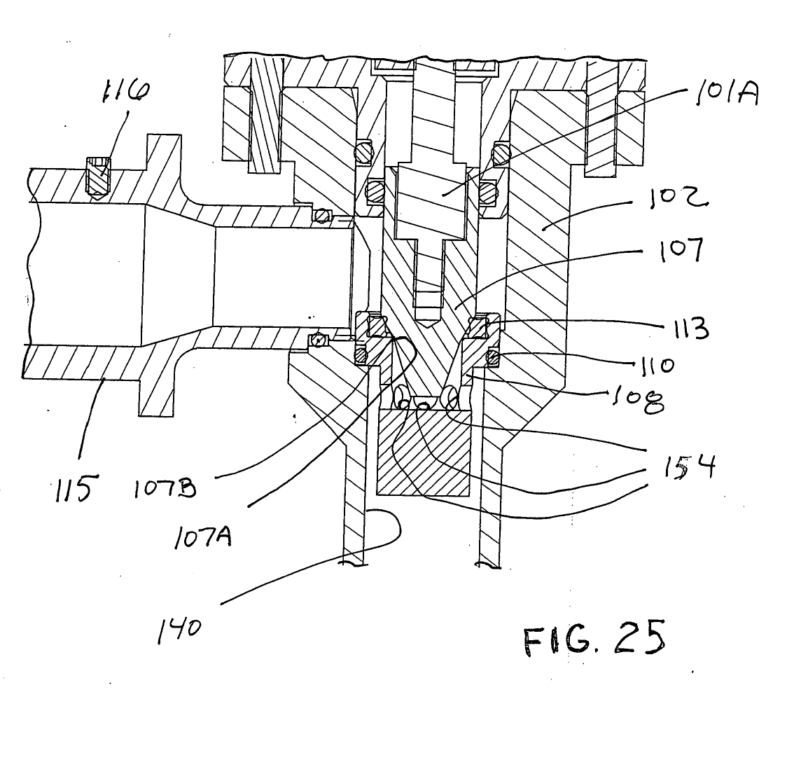

Now that the general description and assembly of the valve 40 has been described, as can be seen, the diffuser 108 fits within the bottom opening 150 (FIG. 7) in the valve 40 and has an upper open end 152 (FIG. 7) with a plurality (16) of generally horizontal openings 154 therein so that the upper interior of the diffuser is connected to the lower annular exterior thereof, via the plurality of openings 154 (FIGS. 5, 24 and 25). The plunger tip 107 engages with the quad-ring 113 to close off the product flow passage 115A in the mounting nipple 115. To prevent crushing of the quad-ring 113, the steel plunger body 107 has a portion 107B which engages with a seat 107A on the valve body to limit downward movement of the plunger 107 into the quad-ring or seal 113 (see FIGS. 24 and 25). As noted, this mounting nipple 115 is sealed to the freeze barrel 7 closing end or face plate opening (See FIGS. 19A to 19E and FIG. 24) on the dispenser by the O-ring 103 and is held in a relative position by tightening the set screw 116 (FIG. 7). The function of the set screw 116 is primarily to prevent rotation of the valve. This function can be preferably better accomplished by providing a key 117A (see FIG. 7A) molded into the top side of an alternative mounting nipple 115′ (otherwise similar to nipple 115) at the location currently occupied by set screw 116 and mounting to the faceplate 2B's key slot 159, as shown in FIG. 19C. While it is preferred the keyway 117A be on the nipple 115′, the locations of the key and keyway could be reversed.

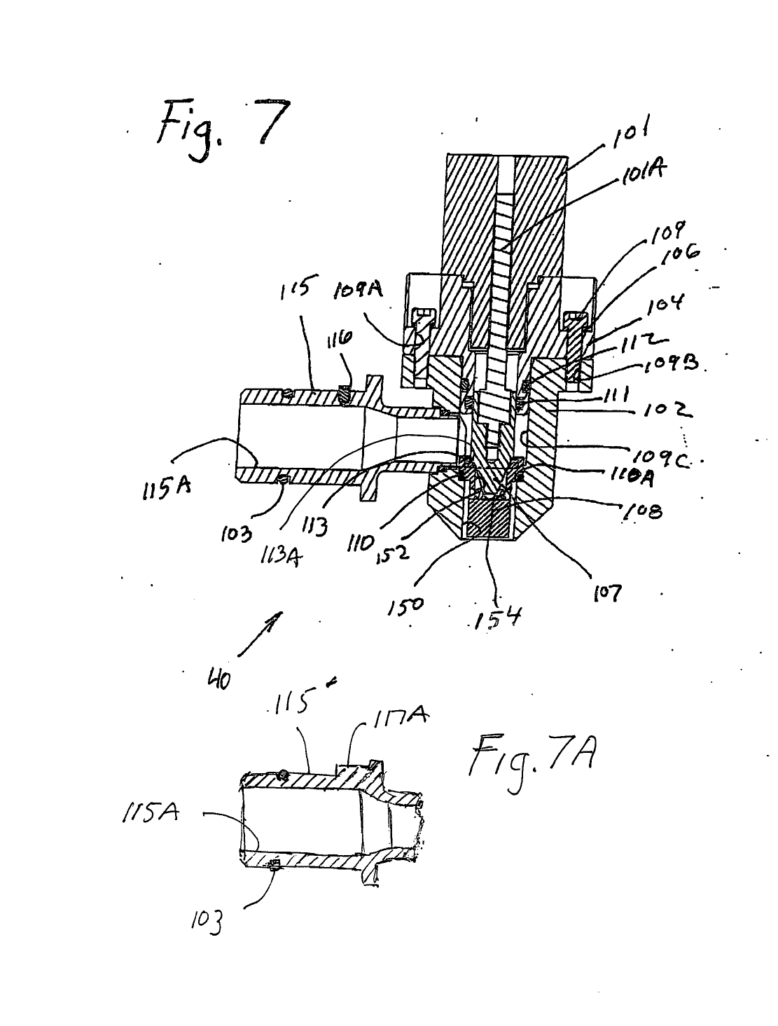

The plunger tip 107 and the actuator 101 armature 101A may be opened electrically and closed either electrically or by a spring, for example, see FIG. 9. When given a signal, power is supplied to the actuator 101 to cause the valve 40 to open and permit FCB to flow out. As noted earlier, the upper and lower portions 102 and 104 of the valve internally are sealed by O-ring 112. The upper end of the plunger tip 107 is sealed to the upper housing 104 by O-ring 111. The plunger tip is sealed in its closed position to the lower body 102 by the quad-ring 113.

As can be appreciated variations in operations can be permitted such as spring biased open or closed and opened or closed electrically, and/or, as will now be discussed, opened mechanically, as is a conventional FCB dispensing valve.

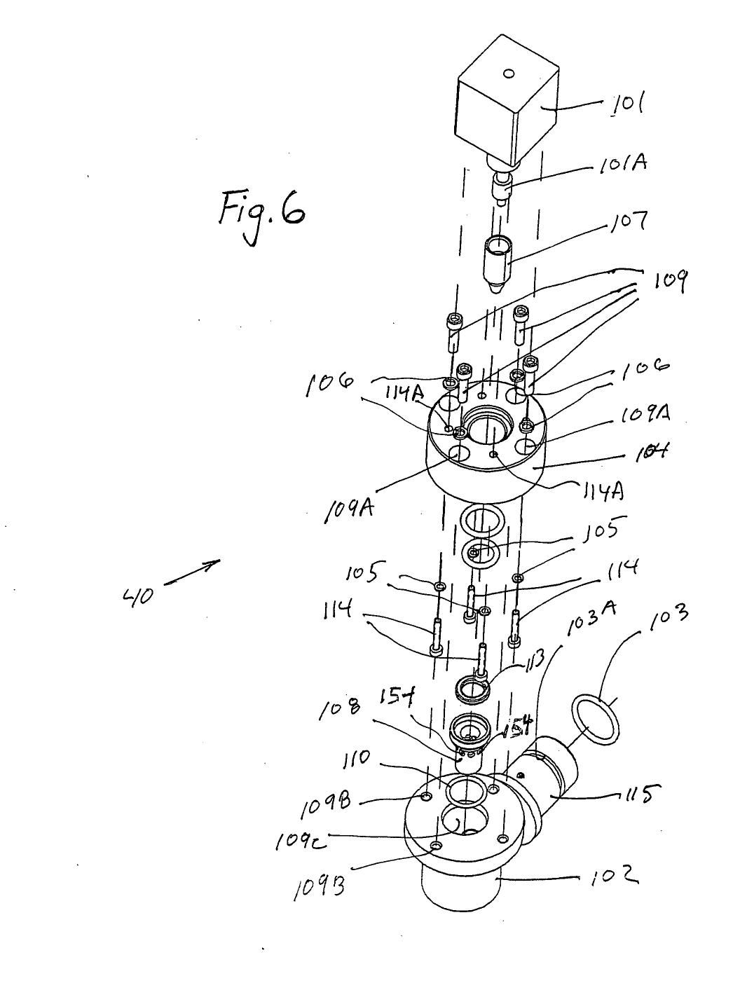

While preferably the valve 40 will be electrically operated, it is designed and constructed to also be, with some adaptation, mechanically operated. The reader is referred to FIGS. 8 to 10 which show such a mechanically operable valve 40M. The parts in valve 40M that are the same as in valve 40 carry the same reference numerals. Different parts in the valve 40M are given different reference numerals. The valve 40M has a mechanical actuator made up of parts 118 to 124 mounted onto the top portion of the valve. As shown, the mechanical version has a pivot pin 121 which carries an actuating lever or arm 124, one or outer end of which the user or consumer can press and the other or inner end which moves a link 118 (equivalent of the armature 101A of valve 40) up and down to open and close the plunger 107 on the seat of O-ring, or preferably quad O-ring 113. In this instance, a spring 119 biases the plunger 107 toward the closed position. The link 118 is connected to the arm 124 with a pin 122 and to the plunger 107 with the pin 120. As is apparent from FIGS. 6 to 8 and 9-10, either the electrical or manual actuators can be easily fitted to form the valve 40 or 40M.

As shown, the plunger 107 may be closed (FIG. 12), opened, about ¼ inch, for full or normal operation (FIG. 13), or moved to fully open, about ½ inch, for purging or purging position (FIG. 14), to purge hard frozen product from the outlet of part 115 or 115′, valve 40 or 40M.

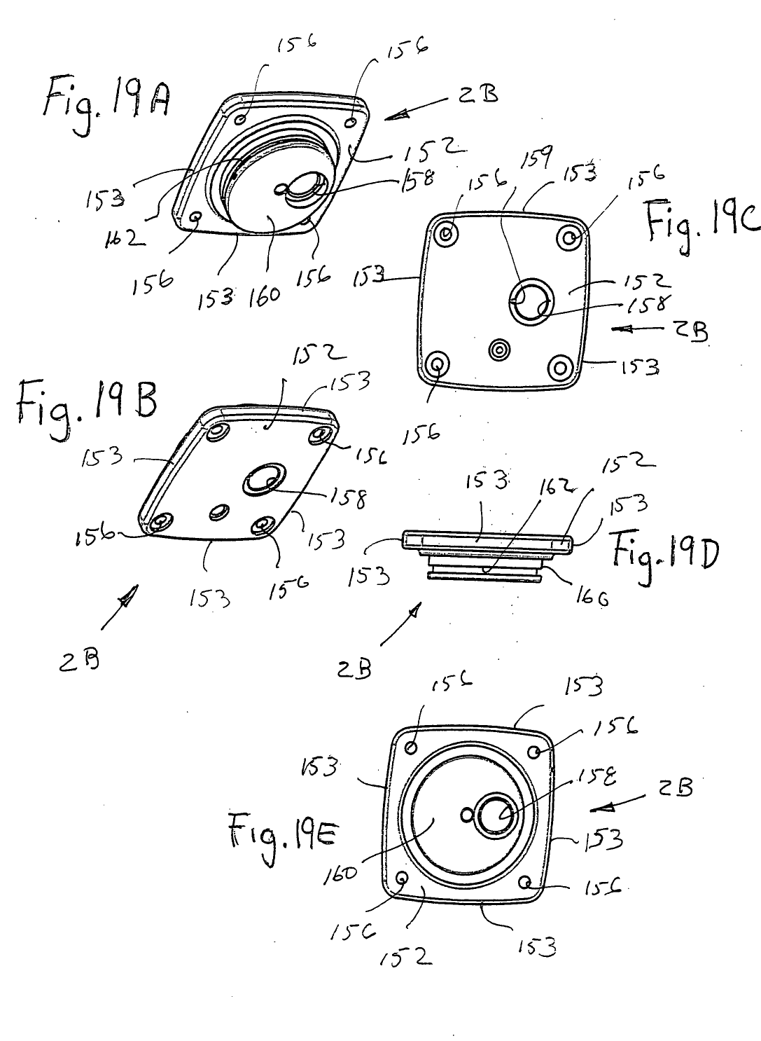

Now that the valve 40 or 40M has been described, we will direct attention to the additive, flavor or injector block 4 shown in FIGS. 1, 2, 11, 17A or 17B and 18A to E. This additive or flavor injector is similar to the one shown in pending U.S. patent application Ser. No. 10/938,329 filed Sep. 10, 2004 and claiming priority of provisional application Ser. No. 60/506,391, both of which are incorporated herein by reference and owned by same assignee of the present application and provisional application Ser. No. 60/601,738. While the flavor injector could be used with the manual version of the valve 40M, for convenience it will be described in conjunction with the electrical version of the valve 40. The flavor injector 4, preferably is mounted below the discharge of the valve 40, is secured thereto to receive the discharge of FCB therefrom and to add the one or more additives, flavors or fluids selected by the user. The above attachment is accomplished by having the lower two screws or studs 130 that mount the valve 40 to the dispenser also pass through openings 132 in the flavor injector.

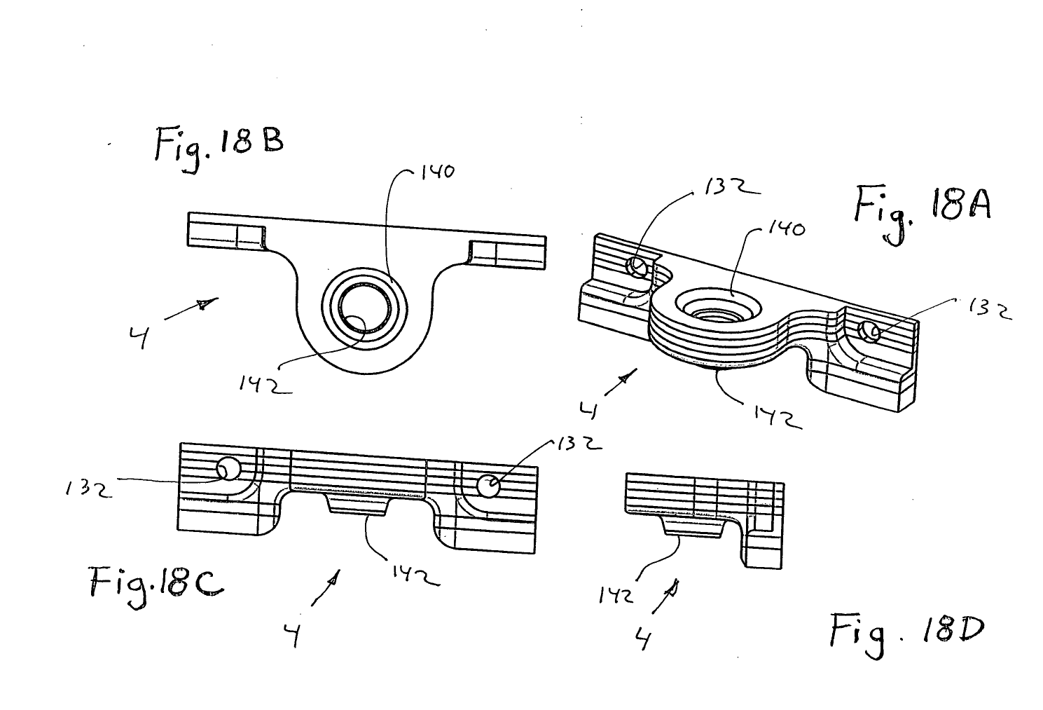

The flavor additives or fluid injector 4 can receive the various additives or flavors about its periphery and, in this instance, has sixteen small radial openings 134, (see FIG. 17A or 17B), four openings connected to each of the four flavors or fluid, as is shown in the above Ser. No. 10/938,329 application. While sixteen openings 134 are provided, more can be used, say up to 64 or even 100. As is shown, the injection block 4 can be made without a mixing chamber (FIG. 17A) above the flavor discharge ports 134 or with such mixing chamber 138 (FIG. 17B). The base FCB product will back up at the valve discharge and mix with the injected additive(s) or flavor(s).

As can be appreciated, the FCB flows from the valve into the opening 140 (see FIGS. 17A, 17B, 24) of the flavor injector block, past the ports 134 to be discharged out the bottom 142 into the customer's cup 5 (FIG. 2). As can be appreciated, if a stream of additive, flavor or fluid is injected through a port 134, and, into the mixing chamber 138 (FIG. 17B) or into opening 142 without the mixing chamber (FIG. 17A), as the product is discharged, a strip of flavor is formed, and it could be the same flavor at several ports or different flavors at different ports, to give flavor strips. If the flavors are periodically stopped while the FCB flow continues, spots or layers of flavor can be deposited in the discharging FCB column. If the cup is relatively twisted, as disclosed in provisional application No. 60/601,738, swirls or curves of flavor could be optionally provided.

Referring now to FIGS. 2, 3 and 15, the regulator manifold 21, 22, 23 or 24 is shown. As they are all similar, only one will be described, manifold 21. As noted earlier, the additive or flavor pumps 29, 30, 31 or 32, supplies additives, flavor or fluid to an additive/flavor manifold shut off valve 51, 52, 53 or 54. From there via line 25/51, the flavor or additive pressure is sensed by a pressure sensors 25, 26, 27 or 28, in this instance “teed” into the line 25/51. This signal is used to determine that additive, flavor or fluid is available to be dispensed. If no or reduced pressure is sensed, the operation of the dispenser could be stopped. From there the flavor or fluid or additive is divided into several parts, in this instance three, and sent through three sets of flow valves (55, 56 or 57) (58, 59 or 60) (61, 62 or 63) (64, 65 or 66) one set for each flavor or fluid additive. The purpose of the multiple paths, in this instance three, is to send the flow through flow rated solenoids (67, 68 and/or 69), (70, 71 and/or 72), (73, 74 and/or 75), (76, 77 and/or 78). Each of the three paths through its flow rated solenoid have a different flow rate, such as 0.10 oz/sec, 0.15 oz/sec or 0.30 oz/sec. Thus, by selecting one or more of these flow rated solenoids paths various flow rates of flavor can be repeatably achieved. For example if solenoid 67 and 68 were opened a combined flow rate of about 0.45 oz/sec would be achieved. The downstream side of the three solenoid valves are combined or connected together and then sent off to the injection block or manifold 4 mounted on the valve 40 or 40M.

As is shown in FIG. 15, these components of the regulator manifold can be conveniently mounted on the manifold 21. The component of one 57 of the flow valves is shown there in an exploded view and the other components are shown being insertable into the manifold body. The manifold has an additive or flavor inlet 80 and an additive or flavor outlet 81 from the manifold. A bracket 79 is provided on the manifold body 21A for mounting purposes. The components 51, 55, 56, 57, 67, 68 and 69 are standard components namely 318305065 (51), (319133051—top, 318455051—O-ring, 310632051—screw, 99012—O-ring, 316996050—spring, 31480011—piston, 317431011—cylinder) (55, 56, 57) AND 620313708 (67, 68, 69) made by Cornelius, Cornelius and Kip, respectively. A person skilled in the art can easily assemble this manifold from the information herein.

Now that the regulator manifolds have been described, the purge/sanitation manifold 50 will be described. As shown in FIGS. 4 and 16, the manifold 50 receives each of the, in this instance, four additives, flavors or fluids from the respective regulator manifolds 21, 22, 23 and 24. Each of the flavors has its own passage 200, 202, 204 and 206, which receives flows from the flavor regulator manifolds 21, 22, 23 and 24, respectively. In each passage 200, 202, 204 and 206, a check valve 49 is provided which prevents backflow back to the regulator manifolds but permits flow of flavor therethrough. Each line is “teed” to a purge/sanitation line 208, 210, 212 and 214 and has a discharge 216, 218, 220 and 222, the latter feeding into the flavor injector block or manifold 4. In the purge/sanitation lines 208, 210, 212 and 214, bi-flow solenoid valves 86, 85, 84 and 83 are connected to the discharge of the bi-flow solenoid valve. These solenoids are called “bi-flow” one or the other of (1) CO₂ gas purge and (2) a sanitizing fluid can move through these solenoids when they are opened. The inlet of the bi-flow solenoid valves 83-86 are ganged together and “teed” into a single discharge line 224.

The CO₂ or other purge gas is provided through the solenoid valve 81 to the line 224. The sanitation solution or sanitizing fluid is also provided through the sanitation solenoid 82 to the line 224. Thus, either purge gas (CO₂) or sanitation solution can be provided through the respective solenoids 81 or 82 through the bi-flow solenoids 83-86 to the lines 216, 218, 220 and/or 222 to purge them of a previous flavor or to sanitize them.

Referring to FIG. 16, the components of the manifold 50 just described can also be arranged in a compact manifold which is connected in the manner shown in FIG. 2 or 2A. The four check valves 49 receive (at their one or right ends 200, 202, 204 and 206 in FIG. 16) the flavor flows from lines connected to pumps 29, 30, 31 and 32 (see FIG. 2 or 2A), and at other ends (left in FIG. 16) are connected to a manifold body 50A. The flavor discharges from the manifold body 50A via flavor outlets 216, 218, 220 and 222. The necessary passages shown in FIG. 4 can be provided in the manifold body 50A as is well known in the plastic injection moulding business. The requisite solenoid valves 81 to 86 can also be connected to the manifold body 50A. To mount the manifold 50 and its manifold body 50A to the dispenser, a manifold bracket 80A is provided.

As noted the manifold 50 contains six flow solenoids: CO₂ purge 81, Sanitation 82, and 83, 84, 85 and 86 for Flavors or fluid 1-4. The solenoids may be 24VAC devices with 0.6 wattage ratings (such as IMI Cornelius part number IMI PN 620313708). Other solenoids could be used. To operate these solenoids, six solenoid driving relays (not shown) are added to controller 2 along with the requisite terminal connections for the harnesses (not shown) that will drive these solenoids. Again from the information herein, a person skilled in the art can easily assemble this manifold.

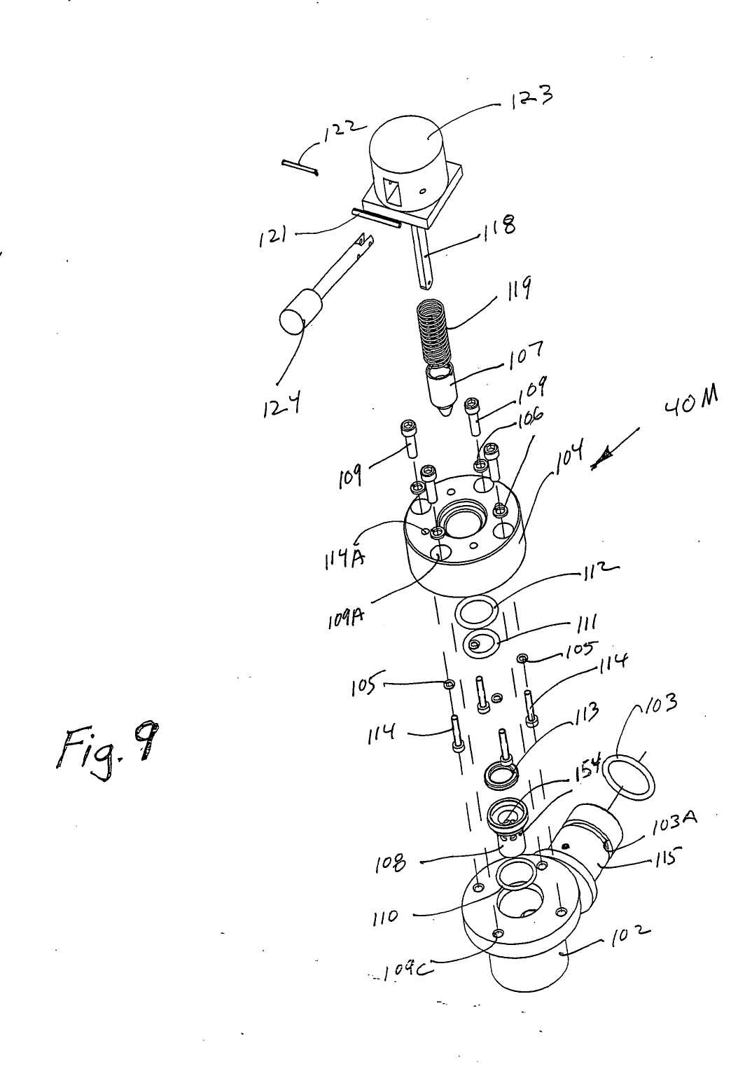

Referring to FIGS. 2, 11, and particularly 19A to 19E, the face plate 2B that forms the outer end of the freeze barrel 7, is shown. The plate 2B has a generally rectangular mounting portion 152, with some what convex curved walls 153, and is secured to the dispenser body 1A. As shown in FIG. 1, four openings 156 are provided in the corners to fit over the four mounting studs 130. The mounting studs fit through openings 156 and nuts 131 (4 each) hold plate 2B firmly in place. The face plate 2B also has an opening 158 to receive the nipple portion 115 of the valve 40 or 40M on its outer side. The other or inner side has a raised circular base 160 with a groove 162 therein for receiving the inner cylindrical wall of the barrel 7. A sealing O-ring 162A (see FIG. 24) fits within the groove 162 to seal with the barrel body.

In FIG. 19C an alternative face plate construction is shown which has a keyway 159 to receive the key 117A of a nipple 115′. The key-keyway construction is preferred over the set screw construction to prevent rotation of the valve and its nipple.

The modulating valve 40 is capable of providing a controlled volume of base material, say FCB, flow of base material for controlled period of time; and can proportionately vary the flow rate based on the position of the flow plunger or piston 107, which is controlled by the actuator 3, which is in turn controlled by a controller 2. The proportioning could be linear, parabolic, cubic, exponential, logarithmic or fuzzy logic, and/or in a manner to prevent splashing of product into the customer's cup.

When flow of product, such as FCB is desired, the controller 2 sends a signal to the actuator 3 (preferably a stepper motor) to actuate a fixed number of steps proportional to a desired distance of travel for the valve piston 101 and 107. This distance determined to be a “middle” open position (FIG. 13) for the modulating valve 40. The actuator 3 moves the piston or tip 107 the appropriate distance (say ¼ inch) dictated by the controller 2 functionally “opening” the modulating valve to flow of the base material. The base material, which could be frozen carbonated beverage (FCB) provided by the FCB dispensing unit, is pressurized. The pressure difference between the base material and the atmosphere forces flow of base material out of the barrel 7, through the opening 158 in the faceplate and to the inlet of and out the modulating valve 40. In the valve 40 (or 40M), the base material flows between the piston 107 and the valve seat 113 (which could be a quad-ring) where the flow rate is proportional to the distance between the piston 107 and the valve seat 113. The base material flow at the outlet of the modulating valve is slowed or annularly shaped (allowing generally uniform velocity across the circular outlet of valve 40) by the diffuser 108 which is located downstream of the valve seat 113. Further, the diffuser 108 insures the flow of base material is dispensed without being overwhelmed by the flow velocity of the base material which would result in unacceptable splatter at the valve outlet or into the cup. The base material flows from the modulating valve outlet. It can flow optionally into two distinctly different locations: a) directly into a cup or b) preferably, into an additive or flavor injection module 4 and then into a cup 5. When flow is no longer desired, the controller 2 sends a signal to the actuator 3 to actuate a fixed number of steps proportional to a desired distance of travel for the valve piston 107. This distance determined to be a “closed” position (FIG. 12) for the modulating valve 40. The actuator 3 moves the piston 107 the appropriate distance dictated by the controller 2 to a position where the piston seats 107 against the valve seat 113 set into the diffuser, functionally “closing” the flow of pressurized base material. The actuator 107 could be provided with (see FIG. 24) a rotary position sensor or encoder such as 107C or without any such device (see for example, FIG. 7).

Two procedures are used during sanitation and/or flavor purge to control the relays for the purge manifold 50. This manifold 50 controls flow of C0₂ to the additive or flavor injector block 4 to prevent additive or flavor carryover between drinks and allow sanitizing solution to be pumped through the additive or flavor lines and flavor injector block.

Sanitizing Sequence

The Control System (including controller 2) provides for three means of initiating the sanitizing sequence: i) by manually initiating it with keypad strokes on keypad 10C in FIG. 1B, ii) through a device connected to port 43, or iii) by time settings in the controller 2 and the controller's internal clock.

The manual method, for example could be initiated by: the user simultaneously depressing two of the input buttons, say the “Layer” and “Stripe” buttons, as could be on the interface 4A or 4B, continuously for 3 seconds. Then indicia (not shown), such as LED's on keypads 4A or 4B could FLASH to indicate the sanitizing sequence mode is occurring. The user could, for example, then initiate sanitizer flow by simultaneously holding the “flow” and “flavor 1” buttons for 1 second. This energizes the “Sanitation” solenoid and the “Flavor 1” solenoid for say about 5 seconds. If “purge” is provided and desired this is followed by energizing “CO₂” solenoid and the “Flavor 1” solenoid for 1 second. This is repeated as many times as the user wishes such as until the unit is fully sanitized. To flush the remaining flavors, the user initiates similar flow by simultaneously holding the “flow” and one of the other “flavor 2-4” buttons for 1 second. This process is repeated until all four flavors have been “sanitized”. The process in these steps is repeated with the corresponding syrup flavor in place of the sanitizing solution. This purges the sanitizing solution and removes CO2 bubbles from the injected flavor/fluid lines. The user stops or ends the sanitizing sequence by, for example, simultaneously depressing the same two buttons, say the “Layer” and “Stripe” buttons, continuously for 3 seconds. The indicia, the LED's on keypad stop flashing to indicate sanitizing sequence mode is no longer active. An alternate method to end sanitizing sequence is a 30 second time-out if no activity is detected from the keypad.

As to the timed method: This method is the same as the manual method except the timer/controller initiates and carries out the sanitizing sequence. The system can be set up so that nothing else can happen while the LED's blink letting the user know the sanitizing sequence mode is active. The controller 2 pulls the “time of day’ from the controller 6. The elapsed time between sanitizing sequences is a value pre-stored on an EEPROM on the memory of the controller 2. Initially this is a fixed value but is alterable by a laptop in communication with the controller 2, via port 43.

Flavor Carryover Prevention Sequence

It is important to control the delivery of injected flavors in a manner that repeatedly delivers the selected flavor(s), and only the selected flavors desired by the user. Accomplishing this requires that no “carryover” of flavors from a selected drink is deposited in a subsequent drink. The sequence can be, for example, set up as follows: The drink pour time is separated into three discrete time intervals: 1) T(time)dead, ii) Tflavor, and iii) Tco₂ purge. Tdead is defined as the time at the beginning of the pour of FCB where FCB is flowing but the selected flavor flow is intentionally disabled for a fixed period of time. This time resides in EEPROM in the controller 2 and is pre-programmed but can be altered by a laptop computer in communication with the controller, via port 43. TCO₂ purge is defined as the time at the end of the pour of FCB when the flow button is released (or between flavors in a layered pour) where FCB is flowing but the selected flavor flow is intentionally disabled for a fixed period of time. The C0₂ purge path is enabled during this time. This time resides in EEPROM in the controller 2 and is pre-programmed but can be altered by a laptop computer in communication with the controller, via port 43. Tflavor is defined as the time, for example, in the middle of the pour of FCB when the flow button is depressed and the selected flavor(s) is (are) flowing. The purge/sanitation manifold provides the CO₂ for the carryover prevention sequence. In FIG. 16, the CO₂ solenoid 81 is energized and the corresponding flavor(s) solenoids 83, 84, 85 and/or 86 are energized. This allows CO₂ to flow from the source 18, through the purge/sanitation manifold 50 and into the flavor injector block 4, and out the valve 40 and injector block 4, of present.

Products Purge Sequence

It is important to guarantee reliable operation of the control system, including controller 2. Sometimes the flow path becomes jammed at the outlet of the FCB product barrel 7. This is usually due to chunks for frozen FCB that can't fit through the normal valve 40 discharge opening. Sometimes it is necessary to open the valve wider than the normal discharge to allow the clog or jam to pass through.

This sequence describes that operation. The user carefully positions a large container or cup 5 tightly to the outlet below the valve 40. This is to prevent splashing as clogs or jams come out of the FCB product barrel 7. The user selects the “purge” option displayed on the user interface 4A. The controller 2 reads the “purge” signal from the user interface 4A. The controller 2 sends a signal to open the valve 40 plunger 107 to a “more fully open” position (FIG. 14) than the normal beverage dispense position say (½ inch compared to ¼ inch). After 1.5 seconds the controller 2 sends a signal to close the valve 40 plunger 107. This ends the Product Purge Sequence.

Sequence of Operation of the Product Modulating Valve

The product dispensing or modulating valve 40 is attached to a base material (say FCB) source. One attachment method is to an acrylic faceplate 2B itself attached to the barrel 7 of an FCB dispensing unit 1A. The valve 40 is also attached via wire harness 2/3 to an electronic control board or controller 2. The modulating valve 40 has the option of attaching its flow outlet to a flavor injection module 4.

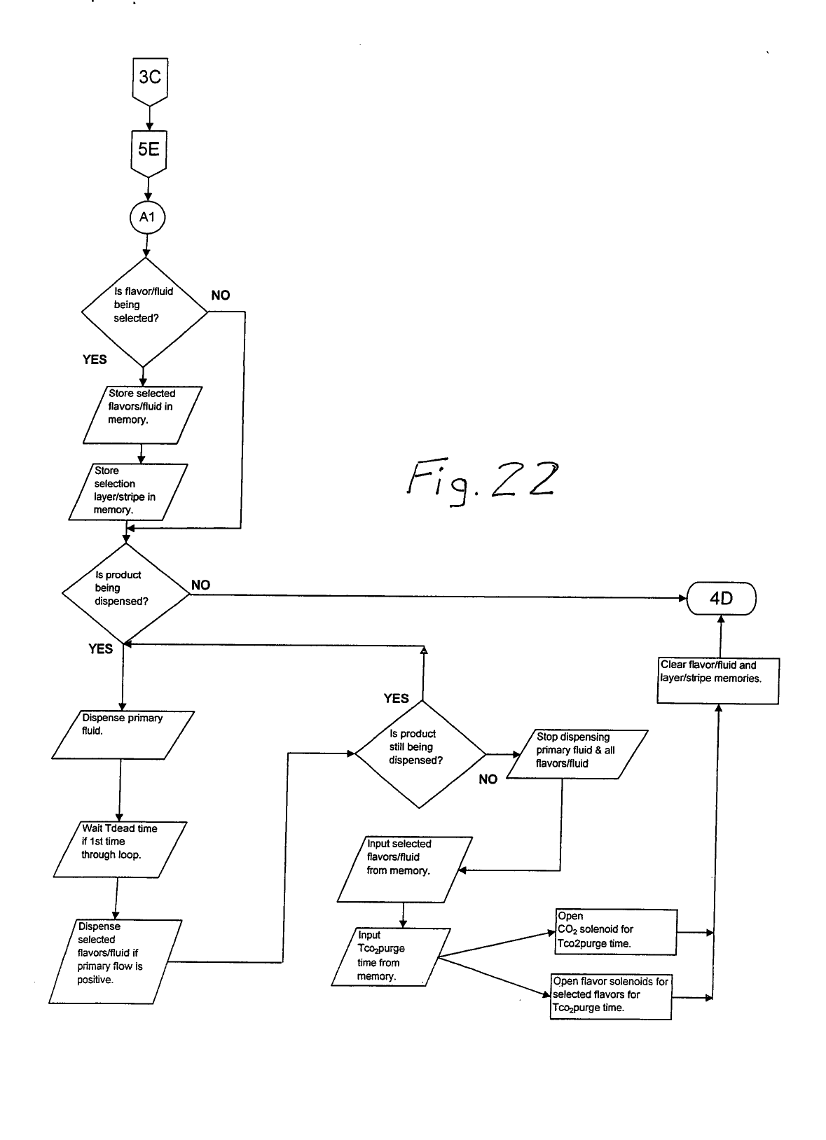

Referring to FIG. 20, an overall flow chart of the operation and/or program or software for the present invention is shown. The various subroutines thereof 2B, 3C and 5E, and 4D, are shown in FIGS. 21, 22, 22A, and 23 respectively. Given the foregoing description, the drawings and the flow charts, FIGS. 20-23, a reasonably skilled programmer can provide the necessary programming.

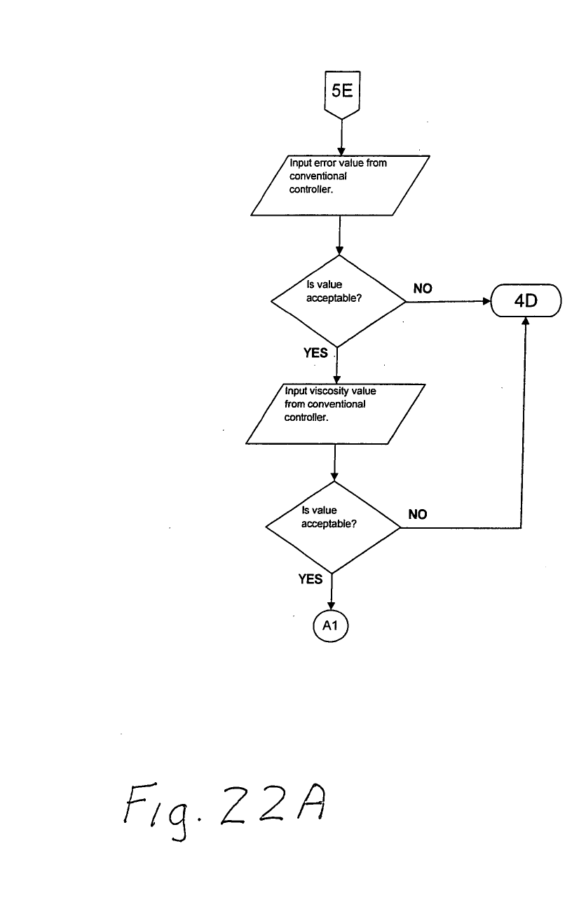

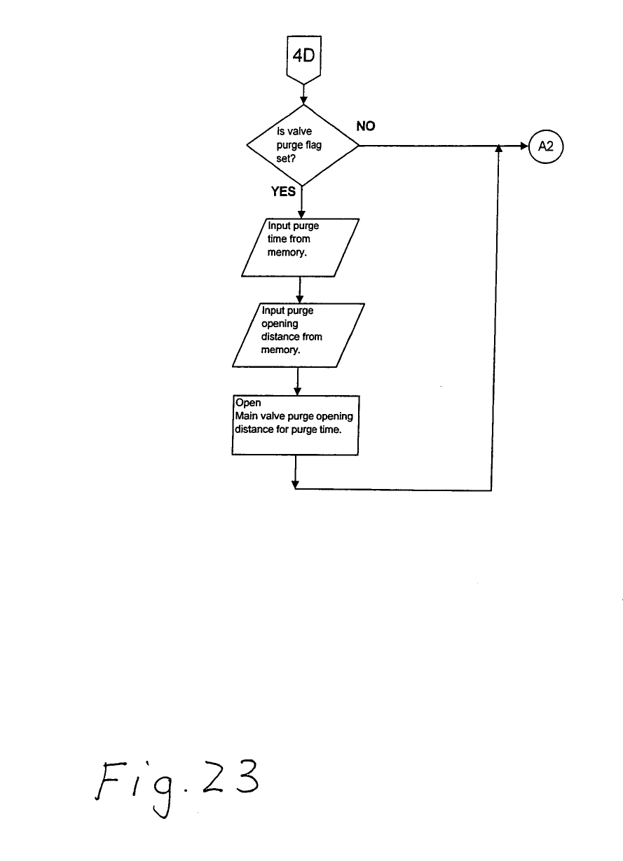

Referring now to FIG. 20, the sequence is shown and refers to the valve controller 2 program. In that program a sanitation flag can be set at an appropriate time, such as once per day. When the sanitation flag is set by the main program, subroutine 2B will be run. The reader should now refer to FIG. 21. As can be seen after testing for the set sanitation flag if the response is “no,” subroutine 2B is stopped and the next one 3C executed. If the response is “yes” then the sequence set forth therein is carried out. For purposes of this application and flow chart in FIG. 16:
Flavor 1 solenoid is 83.
Flavor 2 solenoid is 84.
Flavor 3 solenoid is 85.
Flavor 4 solenoid is 86.
   The subsequent subroutines 3C and 4D including 5E are carried out in a similar manner. As noted in FIGS. 22 and 22A, a test is made for a desired viscosity (see 5E). If not, no dispense is made. If the viscosity/product is acceptable then (going back to FIG. 22) a determination is made if a flavor has been selected, and whether product is being dispensed (flow sensor 9) then flavor/additive is dispensed, and both product and flavor stopped and the controls reset and operation moves to 4D subroutine. As shown in 4D (FIG. 23) after the dispense is stopped, the flavor purge is initiated, and the subroutine stopped and subroutine 4D carried out. After the 4D subroutine, the purge is completed and one returns via A2 to the routines or FIG. 20 checks if there is a power outage and stopped, and if no power outage, then reset for the next dispense. In the present invention, one can prevent dispense when product or unit not ready: The controller 2 is in communication with controller 6. The controller 2 obtains information from controller 6 that can be used to make a decision to disable the dispense of the valve 40 when the product is not ready to dispense. The conditions where dispense needs to be disabled are twofold: 1) Product consistency and 2) FCB machine Error. For Case 1 if the product consistency in not ready as determined by the real-time viscosity reading in controller 6 or if the machine is in the defrost mode as directed by controller 6, controller 2 can determine this via its communication with controller 6 and will disable the dispense until both the defrost is complete and the viscosity is acceptable. For Case 2 the FCB machine has a list of error modes (see, for example, training manual, pages attached for a conventional FCB machine) that are declared by controller 6. Controller 2 can determine this also via its communication with controller 6 and will disable the dispense until the all errors are cleared by controller 6. BOTH Case 1 and Case 2 need to be satisfied in order to dispense product. The dispense disable feature is intended for consumers but the system is provided with a service technician override feature for service purposes only.

Generally in the drink dispensing outs and herein, the amount of carbon dioxide gas dissolved in the beverage is referred to as volumes, as determined by temperature and pressure read from the standard charts or computer. The column supply means the relative bulk gas dissolved in the liquid and, several bulk volumes of gas will disappear into one bulk volume of water. This is a chemical phenomenon of a gas solution. To bring about the gas solution, pressure is needed, and when the pressure is released on the gas, out it comes out of solution again.

When the pressure of the carbon dioxide gas is only of the atmosphere the gas dissolves in amounts determined by the temperature of the water. Gas will dissolve without pressure to 1.71 volumes of carbonation at the freezing temperature of water and to 0.56 volumes of carbonation at 100 degrees F. To get greater amounts of carbon dioxide into solution, it is necessary to increase the pressure of the gas on the water. This is indicated on a chart or computer by the increase in volumes and the gauge pressure beginning at zero (which is atmospheric pressure) and proceeds on to 100 pounds per square inch. Every time the gas pressure is increased by 14.7 pounds per square inch, the gas content increase on multiple of the atmospheric pressure, for a given temperature. For example, at 60 degrees F. one volume of carbon dioxide will dissolve in one volume of product at atmospheric pressure (zero psig). Then as the gauge pressure reaches 14.7 psig, the amount of gas dissolved becomes 2.0 volumes, at 29.4 psig the amount of gas is 3.0 volumes, at 44.1 psig the amount of gas is 4.0 volumes, etc. This same multiple ratio of solubility holds true at normally used temperatures.

Other features and structure of the present invention are provided. In order to keep an audit of drink and syrup dispensed, there is a register in controller 2 for each of the base product (frozen carbonated/noncarbonated), each of flavors or additives, and these can be outputted along with “time” to develop a machine/flavor dispense profile or history. This data is accessed and the registers reset through port 43. The volume of base material is determined by tracking the position of the stepped armature of the valve. Give relative fixed barrel pressure and viscosity, FCB or product the flow will be proportional to physical opening of the valve and the time the valve is open. The advantage is no separate sensor is needed to accomplish this task as it is all done without the need for any special sensors than this disclosed herein.

The volume of each of the flavors is determined in a similar manner using the flow rates of the solenoid valves for that flavor and cumulative time opened have been open. When this data is combined with clock time, an audit of flavor used during the period can be generated. The quantity of the syrup is generally directly proportional to quantity of FCB. Thus reports on syrup condensate can also be generated.

In the present invention, one can do remote software upgrading: The communications port 43 on controller 2 can be used to: i) update the software resident on controller 2, ii) send commands for real-time control of controller 2 or iii) monitor/log the performance of controller 2. This can be accomplished through a communication cable attached between port 43 and an external device such as a laptop computer, PDA, or other custom device designed for this purpose. Further a modem could be connected to the serial port 43 through a communication cable with the output of the modem connected to a hardwired telephone line or wireless telephone connection. The telephone line when connected to a second modem could allow a laptop computer, PDA or other custom device to perform the same functions at a remote location.

In order to minimize or eliminate splashing of FCB product into a cup, and perhaps out of the same and onto the customers, the discharge flow rate from the valve can be controlled. The ability to control discharge of the FCB helps in maintaining a proper or desired ratio of FCB to flavor. For example if the FCB was discharge 16 ounce of product and a flavor were chosen, the flavor quantity would be matched to the FCB flow rate or amount to keep ratio of FCB to flavor constant or nearly so. If “stripe” is selected, for example, with the FCB set via stepped valve to 5 ounce/sec, the flavors could be injected say 0.3 ounce/sec in the following manner:

| | |
|---|---|
| select 1 flavor | one selected valve opens at the .3 ounce/per second |
| | flow rate |
| select 2 flavors | the two selected flavor solenoid valves open at .15 |
| | ounces/per second flow rate |
| select 3 flavors | the three selected flavor the three solenoid valves open |
| | at .1 ounces/per second flow rate |

Should the customer choose layer and say four flavors, each of the flavors selected come on sequential in the order selected and will remain for the time period preprogrammed (say 0.5 sec) at the flow of 0.3 ounces per second.

Of course, if “layer” or stripe” is selected, the FCB carries the base syrup flavor.

The diffuser, such as 108 in FIG. 7 slows down the discharge; prevents splashing and locates the discharge FCB in an ideal, this instance, annular form, so that the injected additive or flavor can be more closely placed in the product, as compared to a circular nozzle outlet without a diffuser. The flow path is from 109C, past the plunge tip 107 and quad ring 113, through the center upper interior of the diffuser, existing through at generally right angles through plural outlets into the annular discharge formed by the chamber 150 of the valve and outer circumference of diffuser bottom. As noted above alternatively there, the product could be discharged directly from the valve into a cup or from the valve through the additive or flavor injector and then into the cup.

### PRIOR ART

Control Panel Error Descriptions

The following section describes the error messages displayed on the Control Panel, the error priority, and the appropriate actions to be taken.

Errors are displayed on the following menus:
Main menu (BARREL STATUS)—menu 1
ON/OFF/MOTOR menu (CHANGE BARREL STATUS)—menu 3
BARREL DATA menu—menu 13
SET DEFROST menu—menu 17
ERROR menu—menu 20

Errors are displayed in the above menus differently. The response to error conditions are listed below.

COMO Error: There is no communication between the J1 connector on the display board and the J17 connector on the main board.

ELECTRONICS Error: Means 1 of 2 things:
Communication has been not established or broken between the main board and 1 or more of the product delivery boards for ten consecutive communication cycles.
Failure of the real time clock chip. The new controls will display a “CLOCK ERROR” message.

HOT GAS Error X: Indicates that the barrel outlet sensor for barrel X exceeded 120° F. for 2 minutes. Do not restart unit. Immediately call IMI Service at (800) 238-3600.

HIGH VOLTAGE GENERATED Errors: It is possible to generate Electronic or Como errors by routing phone lines or low voltage communication lines in the vicinity of high voltage components on the Inverter Board.

LOW VOLTAGE GENERATED Errors: It is also possible to generate these errors if low voltage communication wires or phone cables are in the vicinity of the Inductor on the Main Board. That would be the black capacitors ori the Invertor Board and the wire wrapped coil on the Main Board.

LOW or HIGH VOLTAGE Error: This message means that the incoming voltage is out of specification (180V to 260V) for the unit.

LOW VOLTAGE Error: If the voltage at the junction box is good, high voltage may not be getting up to the main board. Check this voltage at J10 on the main board. If the voltage is good at the board and the low voltage error remains, main board is bad. Display voltage to be ±5 VAC from measured J10 Voltage.

DRIVE Error: The motor has been commanded to rotate but will not rotate.

OVER TORQUE Error: This error occurs when the motor load is greatly increased and causes the barrel viscosity to be more than 250 and the motor is still turning. It can also occur when the inverter board has a problem. If the viscosity is less than 25 with the motor running, the high viscosity reading could have been because of a mechanical load.

REFRIG Error: Means that a specific evaporator has NOT been satisfied within a set time limit. The entire refrigeration system will be disabled. The REFRIG error time limits are:
Freeze Barrel: 46 minutes; Ice Bath: 120 minutes for 60 Hz or 240 minutes for 50 Hz.

SYRUP Error: Syrup supply empty.

CO2 Error: Carbon dioxide supply empty.

H2O Error: Water supply empty.

SENSOR Error: Means that a thermal sensor (thermistor) is not functioning property.

During a refrigeration cycle, if a barrel sensor's reading is at 97° F. or at −30° F. for more than 600 seconds, the control system will display a SENSOR ERROR for that evaporator. During a refrigeration cycle, if a ice bank sensor's reading is at 49° F. or at −30° F. for more than 2400 seconds, the control system will display a SENSOR ERROR for the Ice Bank.

NOTE: The 5600075xx Series controls will have an upper limit of 150° F. for barrel sensors.

| | | | System Response | | | | | |
|---|---|---|---|---|---|---|---|---|
| | Display | Error Reset | | | | Condition After | Display Output | |
| Error | Priority | Response | Comp | Motor ¹ | Blend ⁴ | Error Reset | Menu 1, 3, 13, 17 | Menu 20 |
| Communication | 1a | Cycle | OFF* | OFF | OFF | OFF | COMMO | COMMUNICATION |
| | | Power | | | | | | |
| Electronics | 1b | Cycle | OFF* | OFF | OFF | OFF | ERROR | ELECTRONICS |
| | | Power | | | | | | |
| Real Time Clock | 1c | Cycle | OFF* | OFF | OFF | OFF | CLOCK ERROR | CLOCK ERROR |
| | | Power | | | | | | |
| Hot Gas Valve | 1d | Cycle | OFF* | OFF | OFF- | OFF | HOT GAS #X | HOT GAS #X |
| | | Power | | | OFF | | | |
| High Voltage | 2a | Auto | OFF* | OFF | OFF | “Last Known | VOLT | HIGH VOLTAGE |
| | | | | | | State” of System | | |
| Low Voltage | 2b | Auto | OFF* | OFF | OFF | “Last Known | VOLT | LOW VOLTAGE |
| | | | | | | State” of System | | |
| Cylinder Drive | 3 | Manual | Cylinder | OFF | ON | “Last Known | DRIVE | DRIVE #X |
| | | | OFF** | | | State” of System | | |
| Over Torque | 4 | Manual | Cylinder | OFF | ON | “Last Known | TORQUE | TORQUE #X |
| | | | OFF** | | | State” of System | | |
| Cylinder Refg | 5 | Manual | OFF* | OFF | ON | “Last Known | REFRIG | BRL REFRIG #X |
| | | | | | | State” of System | | |
| Ice BanK Refg | 6 | Manual | OFF* | OFF | ON | “Last Known | REFRIG | IB REFRIG #Y |
| | | | | | | State” of System | | |
| Syrup Sold Out | 7 | Auto | Cylinder | Motor | OFF | “Last Known | SYRUP | SYRUP #X |
| | | | OFF** | | | State” of System | | |
| CO2 Sold Out | 8 | Auto | OFF* | Motor | OFF | “Last Known | CO2 | CO2 OUT |
| | | | | | | State” of System | | |
| H2O Sold Out | 9 | Auto | OFF* | Motor | OFF | “Last Known | H2O | H2O OUT |
| | | | | | | State” of System | | |
| Cylinder Sensor | 10 | Manual | Cylinder | OFF | OFF | “Last Known | SENSOR | BRL SENSOR #X |
| | | | OFF* | | | State” of System | | |
| Ice BanK Sensor | 10 | Manual | IB OFF** | OFF | OFF | “Last Known | SENSOR | IB SENSOR #Y |
| | | | | | | State” of System | | |

Footnotes:
*The compressor associated with this refrigeration system where the error occurs will be commanded OFF (not “no longer needed).
**The compressor associated with this freeze cylinder/ice bank will stop providing cooling to this specific evaporator.
¹ The “motor condition means the motor will continue operating if it was in operation prior to the error. If the motor was OFF it will remain OFF.
² The “Beeper” will give a 5 beep sequence for each new error that occurs after a beeping sequence is completed.
³ The “Cylinder Status Light” of the affected cylinder will flash green at a 1 Hz rate (50% DC) on all errors.
⁴ The Blender will NOT respond to float activations wen “OFF”, and will respond when “ON” only is previously enabled.

While the preferred method and apparatus of the present invention have been disclosed and described it should be understood that equivalent steps and elements to those set forth in the claims hereto are included or to be included within the scope of those or future claims.

What we claim is:

1. A beverage dispenser for dispensing frozen beverage, comprising a source of semi-frozen product, a valve for dispensing the semi-frozen product, said valve being electrically operable, and electronic control means for operating said valve.

2. A beverage dispenser as in claim 1, further including injector means for injecting an additive into said semi-frozen product.

3. A dispenser as in claim 1, wherein said valve can also be constructed alternatively to be mechanically manually operable.

4. A dispenser as in claim 1, wherein said valve is operable into a normal open position and a closed position.

5. A dispenser as in claim 4, wherein said valve can dispense “jammed” frozen product by opening beyond its normal open dispense position.

6. A dispenser as in claim 1, wherein said valve can close in event of a power failure.

7. A dispenser valve as in claim 6, comprising standby power means for closing said valve.

8. A dispenser as in claim 7, wherein said standby power means comprises a battery.

9. A dispensing as in claim 7, wherein said standby power means comprises a charged capacitor.

10. A dispenser as in claim 2, wherein said injector can add more than one additive into said semi-frozen product.

11. A dispenser as in claim 10, wherein said additive is one of: a flavor, alcohol, low caloric, full caloric, color, gas, essence, chocolate, dairy product, soy product and vitamin.

12. A dispenser as in claim 2, wherein said additive is one of: a flavor, alcohol, low caloric, full caloric, color, gas, essence, chocolate, dairy product, soy product and vitamin.

13. A dispenser as in claim 2, including means for purging said injector means.

14. A dispenser as in claim 2, including means for sanitizing said injector means.

15. A dispenser as in claim 2, including means for adding additive into the semi-frozen product in one or more of strips and layers.

16. A dispenser as in claim 2, wherein said injector means for adding additive forms a plurality of layers.

17. A dispenser as in claim 2, wherein said injector means for adding additive forms a plurality of strips.

18. A dispenser as in claim 2, having a purge/sanitization manifold.

19. A dispenser as in claim 2, having an additive regulator manifold.

20. A dispenser as in claim 2, wherein said regulator manifold comprises two or more standardized flow valves that can be opened to provide a set flow of said additive by opening one or more of said standardized flow valves.

21. A dispenser as in claim 2, wherein said injector means has a mixing chamber below said valve.

22. A dispenser as in claim 2, wherein said valve and injector means are held to the dispenser by collinear fastening means.

23. A dispenser as in claim 1, including means for sensing the quality of the semi-frozen product to be dispensed, and permitting a dispense only when said semi-frozen product is of a desired quality.

24. A dispenser as in claim 1, wherein said dispenser has a motor for mixing/removing said semi-frozen product, and a signal related to said motor is used to determine whether the semi-frozen product is suitable to be dispensed.

25. A dispenser as in claim 1, wherein the valve for the semi-frozen product is adapted to dispense into a cup and the quality of product dispensed is sensed, and none is dispensed made when the dispensed product is likely to splash into the cup.

26. A dispenser as in claim 2, wherein said product can be one of layered, spiraled or layered with additive.

27. A dispense as in claim 1, including a user interface for controlling said dispenser, said user interface being connected to provide input to said control means.

28. A dispenser as in claim 10, including positive shut down means for closing said valve in the event of a power failure.

29. A dispenser as in claim 1, wherein said valve is adapted to dispense into a cup and including a flow diffuser below said valve for minimizing splashing into the cup during dispensing.

30. A dispenser as in claim. 1, wherein said valve includes replaceable seals.

31. A dispenser as in claim 1, wherein said valve provides a controlled volume dispense.

32. A dispenser as in claim 1, wherein said valve provides a flow for a controlled period of time.

32. A dispenser as in claim 1, wherein said valve can proportionally vary the flow as determined by said electronic control means.

34. A dispenser as in claim 1, wherein said valve includes seals made of one of EPDM and BUNA-N.

35. A dispenser as in claim 34, wherein said seals are replaceable.

36. A dispenser as in claim 1, wherein said valve has an armature, a primary seal and a secondary seal, one of said seals being harder than the other and serves as a stop for relative movement of said armature of said valve.

37. A dispenser as in claim 1, wherein said valve has an actuator, said actuator being an armature, said valve having a stator for cooperating with said armature to open and close said actuation of said valve.

38. A dispenser as in claim 1, including means for sensing the presence of product, means for sensing the viscosity of the product, means for determining whether a suitable product can be dispensed, said means indicating a signal to said control means, and said control means dispensing said product only when said means for sensing have so signaled to said control means.

39. A dispenser as in claim 2, including means for sensing the presence of product, means for sensing the presence of additive, means for sensing the viscosity of the product, and means for determining whether a suitable product with an additive could be dispensed, each of said means providing a signal to said control means, and said control means permitting dispense of said product and additive only when said means for sensing have so signaled to said control means.

40. A dispenser as in claim 1, including means for sensing a product dispense and means for storing the sensed product dispensed.

41. A dispenser as in claim 40, including means for reporting the stored sensed product dispensed.

42. A dispenser as in claim 2, including means for sensing an additive dispense and means for storing the sensed additive dispensed.

43. A dispenser as in claim 42, including means for reporting the stored sensed additive dispensed.

44. A method for operating a semi-frozen beverage dispenser having an electrically operated valve, comprising the steps of: initiating operation of the valve by a customer, operating the valve electrically to dispense semi-frozen product, and dispensing the semi-frozen product to the customer.

45. A method for operating a semi-frozen beverage as in claim 44, comprising the steps of selecting an additive and dispensing the additive into the semi-frozen product.

46. A method for building semi-frozen beverage dispenser, comprising the step of providing the dispenser with at least one of an electrically operated and mechanical operated valve for dispensing semi-frozen product.

47. A method of claim 46, comprising the step of providing a plurality of said valves.

48. A method for operating a beverage valve in claims 46 or 47, comprising the step of converting one or more of said electrically operated and mechanically operated valves to the other of mechanically operated and electrically operated valves.

49. A method of claim 44, comprising the step of swapping one of an electrically operated and mechanically operated valve for the other of a mechanically operated and electrically operated valve.

50. A method for operating a semi-frozen product beverage dispenser, comprising providing a semi-frozen product dispensing valve, providing a flavor injecting block below said valve for adding two or more flavors dispensing a semi-frozen product through said valve, adding a first flavor to the semi-frozen product dispensed from the valve to said flavor injecting block below the valve, purging of the flavor injecting block below the valve before a second flavor is dispensed into said flavor injecting block.

51. A method for operating a beverage dispenser comprising providing a flavor injecting block for dispensing a flavor into said semi-frozen product, dispensing a semi-frozen product, adding one or more flavors to the semi-frozen product dispensed from said flavor injector block, sanitizing the flavor injecting block.

52. A method for electrically operating a beverage dispenser having a valve for dispensing a semi-frozen beverage comprising electrically operating said valve.

53. A method as in claim 52, comprising the step of operating the dispensing valve electrically in the event of a power failure, closing the valve.

54. A method for constructing a valve for dispensing a semi-frozen beverage product, adding one of a mechanical or electrical actuator to said valve.

55. A dispenser as in claim 1, further comprising means to sense conditions of non-dispense relating to refrigeration, semi-frozen product out, syrup out, semi-frozen product viscosity, and to prevent dispense in such conditions.

56. A dispenser as in claim 55, comprising means to sense the indication of additive out and to prevent dispense in a condition of additive out.

57. A dispenser as in claim 1, 2 or 10, including means for remotely controlling dispenser operation.

58. A dispenser as in claim 1, 2 or 10, including means for remotely altering dispenser operation.

59. A dispenser as in claim 1, 2 or 10, including means for logging dispenser performance.

60. A dispenser as in claim 1, 2 or 10, including means for logging dispenser output of semi-frozen product.

61. A dispenser as in claim 1, 2 or 10, including means for logging dispenser usage of syrup.

62. A dispenser as in claim 1, 2 or 10, having a dispensing barrel, and means to modulate valve position controlling semi-frozen product flow in relation to one or more of semi-frozen product viscosity, semi-frozen product barrel pressure, and a stored flow table.

63. A dispenser as in claim 2, wherein said valve is operable into a normal open position and a closed position, said valve can dispense “jammed” frozen product by opening beyond its normal open dispense position, said valve can close in event of a power failure, standby power means for closing said valve, said standby power means comprising one of a battery and a charged capacitor.

64. A beverage dispenser as in claim 63, wherein said injector means for injecting an additive into said semi-frozen product is located below said valve.

65. A dispenser as in claim 64, wherein said injector means can add more than one additive into said semi-frozen product.

66. A dispenser as in claims 64 or 65, wherein said additive is one of a flavor, alcohol, low caloric, full caloric, gas, essence, chocolate, dairy product, soy product, vitamin.

67. A dispenser as in claim 64, including means for purging said injector means.

68. A dispenser as in claim 64, including means for sanitizing said injector means.

69. A dispenser as in claim 64, having an additive regulator manifold for providing consistent amounts of additive.

70. A dispenser as in claim 64, including means for adding additive into the semi-frozen product in one or more of strips and layers.

71. A dispenser as in claim 68, including means for purging said injector means and an additive regulator manifold for providing consistent amounts of additive.

72. A dispenser as in claim 64, wherein said injector can be made with a mixing chamber.

73. A dispenser as in claim 63, wherein said valve is held to the dispenser by fastening means.

74. A dispenser as in claim 64, wherein said valve and injector means are held to the dispenser by the collinear fastening means.

75. A dispenser as in claim 63, wherein said dispenser has a motor for mixing/removing said product, and a signal related to the power used by said motor is used to determine whether the product is suitable to be dispensed.

76. A dispenser as in claim 75, wherein the valve for the semi-frozen is adapted to dispense into a cup and the quality of product dispensed is sensed, and no dispense made when the dispensed product is likely to splash into the cup.

77. A dispenser as in claim 63, including a user interface for controlling said dispenser.

78. A dispenser as in claim 64, including a user interface for controlling said dispenser, its valve and injector means.

79. A dispenser as in claim 63, wherein said valve includes replaceable seals.

80. A dispenser as in claim 79, wherein said valve includes seals made of one of EPDM and BUNA-N.

81. A dispenser as in claim 80, wherein one of said seals being harder than the other and serves as a stop for relative movement of said valve.

82. A dispenser as in claim 63, including means for sensing a product dispense and means for storing the sensed product dispensed.

83. A dispenser as in claim 64, including means for sensing an additive dispense and means for storing the sensed additive dispensed.

84. A dispenser as in claim 82, including means for sensing an additive dispense and means for storing the sensed additive dispensed.

85. A dispenser as in claim 84, including means for reporting the cumulative sensed additive dispensed.

86. A dispenser as in claim 83, including means for reporting the cumulative sensed product dispensed.

87. A dispenser as in claim 85, comprising means to sense the indication of additive out and to prevent dispense in a condition of additive out.

88. A dispenser as in claim 87, including means for remotely controlling dispenser operation.

89. A dispenser as in claim 88, including means for remotely altering dispenser operation.

90. A dispenser as in claim 89, including means for logging dispenser performance.

91. A dispenser as in claim 82, including means for logging dispenser output of semi-frozen product.

92. A dispenser as in claim 91, including means for logging dispenser usage of syrup.

93. A method for operating a semi-frozen beverage dispenser having a plurality of electrically operated valves, providing a flavor injecting block below each said valves for adding one or more additive, and dispensing a semi-frozen product through one of said valves, comprising the steps of: initiating operation of a selected valve and a selected additive by a customer, operating a selected valve electrically to dispense semi-frozen product through said selected valve, dispensing the semi-frozen product to the customer, adding a first additive to the semi-frozen product dispensed from the valve to said flavor injecting block below the valve, purging of the first selected additive injecting block below the valve before a different selected additive is dispensed into said additive injecting block, initiating operation of a selected valve and a different selected additive by said customer, operating the second selected valve electrically to dispense semi-frozen product, and dispensing the second selected additive into said flavor injection block.

94. The method of claim 93, comprising the further step of sanitizing the additive injecting block.

95. A method as in claim 94, comprising the step of operating the dispensing valve electrically in the event of a power failure, closing the valve.

96. A method for operating a beverage dispenser having an electrically operated valve, comprising the steps of: initiating operation of the valve by a customer, operating the valve electrically to dispense beverage product, providing a flavor injecting block below said valve for adding two or more flavors, adding the first flavor to the semi-frozen product dispensed from the valve to said flavor injecting block below the valve, dispensing the beverage product to the customer, purging the flavor injecting block below the valve before a second flavor is dispensed into said flavor injecting block, and sanitizing the flavor injecting block.

97. A method as in claim 96, comprising the step of operating the dispensing valve electrically, closing the valve in the event of a power failure.

98. A beverage dispenser for dispensing a beverage, comprising a source of beverage product, a valve for dispensing the beverage product, said valve being electrically operable, and electronic control means for operating said valve, said valve being electrically operable into a normal open position and closed position, and said valve can close in event of a power failure.

99. A dispenser valve as in claim 98, comprising standby power means for losing said valve.

100. A dispenser as in claim 99, wherein said standby power means comprises a battery.

101. A dispenser as in claim 98, wherein said standby power means comprises a charged capacitor.

102. A dispenser as in claim 1, including a user interface for controlling said dispenser.

103. A dispenser as in claim 2 or 10, including a user interface for controlling said dispenser said valve and said injector means.

104. A dispenser as in claim 103, including means for sensing a product dispense and means for storing a senses product dispensed.

105. A dispenser as in claim 104, including means for sensing an additive dispense and means for storing the sensed additive dispensed.

106. A dispenser as in claim 105, including means for sensing a second additive dispense and means for storing said second sensed additive dispensed.

107. A dispenser as in claim 106, including means for reporting the cumulative sensed product dispensed.

108. A dispenser as in claim 107, including means for sensing an additive dispense, means for storing the sensed additive dispense, and means for reporting the cumulative sensed additive dispensed.

109. A dispenser as in claim 108, comprising means to sense the indication of additive out and to prevent dispense in a condition of additive out.

110. A dispenser as in claim 109, including means for remotely controlling dispenser operation.

111. A dispenser as in claim 110, including means for remotely altering dispenser operation.

112. A dispenser as in claim 1, including means for logging dispenser performance.

113. A dispenser as in claim 112, including means for logging dispenser output of semi-frozen product.

114. A dispenser as in claim 113, including means for logging dispenser usage of syrup.

115. A dispenser as in claim 114, including means for logging dispenser usage of additive.
